(19) United States
(12) Patent Application Publication
(10) Pub. No.: US 2006/0269801 A1
(43) Pub. Date: Nov. 30, 2006

(54) Lead-acid battery electrode body, lead-acid batter, and manufacturing method of lead-acid battery

(75) Inventors: Kyoko Honbo, Ibaraki (JP); Takeo Sakamoto, Mie (JP); Masanori Sakai, Ibaraki (JP); Yasuo Kondo, Ibaraki (JP); Hirofumi Takahashi, Ibaraki (JP)

Correspondence Address: CROWELL & MORING LLP;INTELLECTUAL PROPERTY GROUP, P.O. BOX 14300, WASHINGTON, DC, 20044-4300, US

(73) Assignee: Shin-Kobe Electric Machinery Co., Ltd., Chuo-ku (JP)

(21) Appl. No.: 11/442,241

(22) Filed: May 30, 2006

(30) Foreign Application Priority Data
May 31, 2005 (JP) 2005-158342
Apr. 27, 2006 (JP) 2006-123446

(51) Int. Cl. H01M 16/00; H01M 4/62

(52) U.S. Cl. 429/7; 429/217; 29/623.1

(57) ABSTRACT

In a single plate lead-acid battery of the present invention are respectively formed a positive electrode capacitor layer and a negative electrode capacitor layer on surfaces of a positive electrode plate and a negative electrode plate containing an active substance, and an electric charge is accumulated in the positive electrode capacitor layer and the negative electrode capacitor layer. As a result, the single plate lead-acid battery brings out an output higher than a conventional single plate lead-acid battery.

### BACKGROUND OF THE INVENTION

1. Field of the Invention

The present invention relates to a lead-acid battery electrode body, a lead-acid battery where the electrode body is built in, and a manufacturing method of the lead-acid battery.

2. Description of the Related Art

Conventionally is known an electrode (negative electrode) where an active substance blend paste containing an active substance, activated carbon, and conductive carbon in a lead alloy porous substrate (for example, see paragraphs 0006 to 0009 in Japanese Patent Laid-Open Publication No. 2003-51306). In a lead-acid battery where the electrode is used, because conductive carbon suppresses a polarization of a negative electrode, and conductive carbon and activated carbon mixed together with an active substance increase an electric double layer capacity of the negative electrode, it is enabled to maintain a voltage of the lead-acid battery just after a discharge. As a result, in the lead-acid battery an output thereof is heightened.

In this connection, in recent years as an automobile lead-acid battery is requested the battery of a high output that can instantaneously take out a large current so as to be able to always start an engine even from a cool state. In addition, considering a trend that a load such as a motor mounted on a vehicle increases more and more, an automobile lead-acid battery is desired that brings out an output higher than conventional one. In addition, in an idling stop vehicle as well as a hybrid vehicle where a charge and discharge of a lead-acid battery are frequently repeated, an automobile lead-acid battery is desired that further stably brings out an output higher than conventional one.

Consequently are strongly requested a lead-acid battery that further stably brings out an output higher than conventional one, and a lead-acid battery electrode body used in the lead-acid battery.

### SUMMARY OF THE INVENTION

A lead-acid battery electrode body of the present invention for solving the problem is characterized in that a capacitor layer is formed for accumulating an electric charge on a surface of an electrode containing an active substance.

The lead-acid battery electrode body accumulates an electric charge in a capacitor layer. As a result, in a lead-acid battery where the lead-acid battery electrode body is used brings out an output higher than conventional one.

In addition, in accordance with such a lead-acid battery electrode body, it is enabled to provide a lead-acid battery equipped with the lead-acid battery electrode body where a capacitor layer is formed for accumulating an electric charge on a surface of an electrode containing an active substance.

A manufacturing method of such a lead-acid battery can be configured so as to comprise a first process of adjusting a capacitor layer forming composition matter containing an activated carbon, a binder, and a conductive auxiliary agent; a second process of extending the composition matter on a surface of an electrode containing an active substance and forming a capacitor layer; and a third process of housing the electrode, where the capacitor layer is formed, in a casing together with an electrolyte.

### BRIEF DESCRIPTION OF THE DRAWINGS

FIG. 1 is a configuration illustration of a single plate lead-acid battery where electrode bodies (lead-acid battery electrode bodies) related to a first embodiment of the present invention are built in.

FIG. 2 is a perspective view illustrating a configuration of an automobile lead-acid battery where electrode bodies (lead-acid battery electrode bodies) related to a second embodiment of the present invention are built in, and is a drawing including a cutout at part of an electrolysis bath and the electrode bodies.

FIG. 3 is a perspective view illustrating a configuration of a cylindrical lead-acid battery where electrode bodies (lead-acid battery electrode bodies) related to a third embodiment of the present invention are built in, and is a drawing including a cutout at part of an electrolysis bath.

FIG. 4 is a perspective view illustrating a configuration of a valve-regulated lead-acid battery where electrode bodies (lead-acid battery electrode bodies) related to a fourth embodiment of the present invention are built in, and is a drawing including a cutout at part of an electrolysis bath.

FIG. 5A is an appearance perspective view of a tubular type lead-acid battery related to a fifth embodiment of the present invention; FIG. 5B is an appearance perspective view of a stacked electrode plate cluster configuring the tubular type lead-acid battery; and FIG. 5C is an appearance perspective view of electrode bodies (lead-acid battery electrode bodies) related to the fifth embodiment.

FIG. 6A is a perspective view of a lead-acid battery electrode body of another embodiment; FIG. 6B is an X-X section view of FIG. 6A.

FIG. 7 is a graph showing discharge curves of lead-acid batteries made in examples and comparison examples of the present invention; vertical and horizontal axes show a discharge voltage (V) and a discharge time (sec), respectively.

### BEST MODES FOR CARRYING OUT THE INVENTION

### First Embodiment

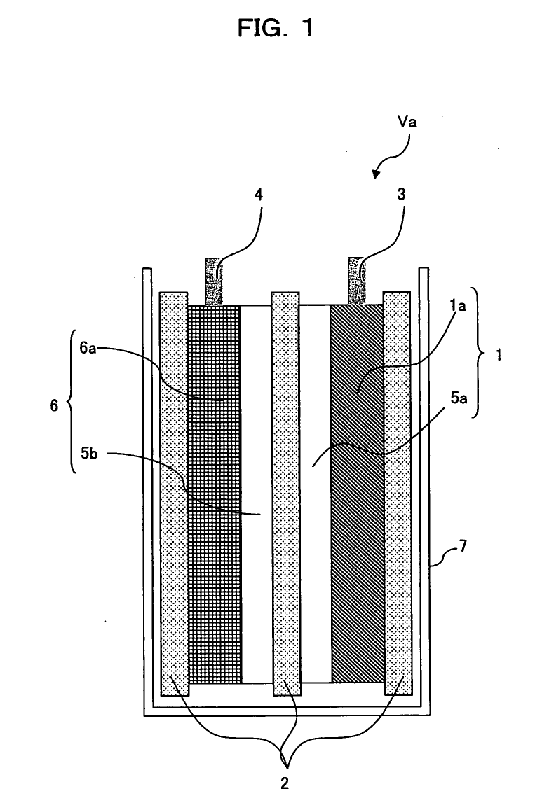

Here will be described a first embodiment of the present invention in detail, referring to a drawing as needed. Firstly, as an example of the present invention will be described a single plate lead-acid battery of a simple structure and electrode bodies built therein. In a referred drawing FIG. 1 is a configuration illustration of a single plate lead-acid battery where electrode bodies related to the first embodiment are built in.

As shown in FIG. 1, a single plate lead-acid battery Va comprises a positive electrode body 1 (lead-acid battery electrode body) and a negative electrode body 6 (lead-acid battery electrode body), partitions 2, and a casing 7 for housing the members together with an electrolyte (not shown) containing sulfuric acid (H₂SO₄).

The positive electrode body 1 comprises a positive electrode plate 1a and a positive electrode capacitor layer 5a formed on one side thereof the negative electrode body 6 comprises a negative electrode plate 6a and a negative electrode capacitor layer 5b formed on one side thereof.

In the single plate lead-acid battery Va are respectively disposed the positive electrode body 1 and that of the negative electrode body 6, and the positive electrode capacitor layer 5a and the negative electrode capacitor layer 5b, so as to face each other. In addition, between the positive electrode capacitor layer 5a and the negative electrode capacitor layer 5b, outside the positive electrode plate 1a (opposite side of the positive electrode capacitor layer 5a), and outside the negative electrode plate 6a (opposite side of the negative electrode capacitor layer 5b) are disposed the partitions 2, respectively.

The positive electrode plate 1a may be known one and can be obtained, for example, by filling a positive electrode active substance paste containing such as a lead powder, red lead, and a filler in a collector grid composed of lead-calcium-tin alloy and thereafter by drying it. Meanwhile, in the positive electrode plate 1a, as well known, lead dioxide (PbO₂) of an active substance (positive electrode active substance) results in being produced by being conversed. To the positive electrode plate 1a is attached a positive electrode ear 3 for collecting electricity.

The negative electrode plate 6a may be known one and can be obtained, for example, by filling a negative electrode active substance paste containing such as a lead powder, a carbon powder, and a filler as an active substance (negative active substance) in a collector grid composed of lead-calcium-tin alloy and thereafter by drying it. To the negative electrode plate 6a is attached a negative electrode ear 4 for collecting electricity.

The positive electrode capacitor layer 5a and the negative electrode capacitor layer 5b (hereinafter simply referred to as “capacitor layers 5a, 5b” in some case) respectively contact the positive electrode plate 1a and the negative electrode plate 6a so as to respectively become same potentials as the active substances of the plate 1a and the plate 6a. The positive electrode capacitor layer 5a and the negative electrode capacitor layer 5b accumulate an electric charge and contain activated carbon, a binder, and a conductive auxiliary agent.

As described later, activated carbon adsorbs or desorbs a predetermined ion to/from a fine porosity thereof in charging or discharging the single plate lead-acid battery Va.

Although the activated carbon may be known one, a specific surface area thereof is preferably not less than 700 m²/g and not more than 3500 m²/g. In addition, considering a balance between an improvement of an output characteristic and cost of the single plate lead-acid battery Va, the specific surface area is more preferably not less than 1200 m²/g and not more than 1800 m²/g.

A binder adheres the respective active substances of the positive electrode capacitor layer 5a and the negative electrode capacitor layer 5b to the respective positive electrode plate 1a and negative electrode plate 6a so that the capacitor layers 5a, 5b become a same potential, that is, the active substances and at least the activated carbon become the same potential. In addition, the binder binds the activated carbon and a conductive auxiliary agent described later.

As a binder can be cited, for example, a fluorine resin such as polytetrafluoroethylene and polyfluorovinylidene; a cellulose resin such as methylcellulose, carboxymethylcellulose, sodium carboxymethylcellulose, hydroxypropyl methylcellulose, hydroxyethylmethylcellulose, and hydroxyethylcellulose; a synthetic rubber such as ethylene-propylene rubber, styrene-butadiene rubber, chlorosulfonated polyethylene rubber, nitrile rubber, and methacrylate methyl-butadiene rubber; and in addition, such polyethylene oxide, polyvinyl alcohol, butyl glycol acetate, and ethyl diglycol acetate. Specifically is preferable a combination between any binder excellent in an adhesion force such as polytetrafluoroethylene, ethylene-propylene rubber, styrene-butadiene rubber, chlorosulfonated polyethylene rubber, nitrile rubber, and methacrylate methyl-butadiene rubber; and any binder abounded in increasing viscosity such as polyvinyl alcohol, methylcellulose, carboxymethylcellulose, sodium carboxymethylcellulose, hydroxypropyl methylcellulose, hydroxyethylmethylcellulose, hydroxyethylcellulose, and polyethylene oxide, because an adhesion between the positive electrode capacitor layer 5a and the positive electrode plate 1a and an adhesion between the negative electrode capacitor layer 5b and the negative electrode plate 6a become easy. In addition, the binder preferably melts at not less than 100 degrees Celsius and not more than 350 degrees Celsius. In such the positive electrode capacitor layer 5a and the negative electrode capacitor layer 5b containing such a binder, by forming a melt layer (melt adhesion layer) on their surfaces in heating, the adhesions thereof to the plates 1a, 6a respectively become better. In this connection, the positive electrode capacitor layer 5a and the negative electrode capacitor layer 5b containing polytetrafluoroethylene form a melt layer (melt adhesion layer) by being heated at not less than 200 and not more than 350 degrees Celsius.

A conductive auxiliary agent establishes a better electron conductivity (conductivity path) between the activated carbon and any one of the positive electrode plate 1a and the negative electrode plate 6a as well as those of the positive electrode capacitor layer 5a and the negative electrode capacitor layer 5b themselves.

As the conductive auxiliary agent can be cited, for example, such carbon black, acetylene black, furnace black, natural graphite, artificial graphite, isotropic graphite, mesophase carbon, pitch carbon fibers, vapor phase epitaxy carbon fibers, nanocarbon, and PAN (Polyacrylonitrile) carbon fibers. Among others, carbon black, acetylene black, and furnace black are preferable because they are small in primary particle diameter as several tens nanometers to one hundred nanometers and the electron conductivity can be made better by adding a small amount thereof.

With respect to contents of activated carbon, a binder, and a conductive auxiliary agent in the positive electrode capacitor layer 5a and the negative electrode capacitor layer 5b, that of the activated carbon is preferably not less than 15 mass % and not more than 94 mass %; that of the binder is preferably not less than 1 mass % and not more than 50 mass %; and that of the conductive auxiliary agent is preferably not less than 5 mass % and not more than 80 mass %. More preferably, that of the activated carbon is not less than 40 mass % and not more than 87 mass %; that of the binder is not less than 3 mass % and not more than 30 mass %; and that of the conductive auxiliary agent is not less than 5 mass % and not more than 30 mass %.

In addition, the positive electrode capacitor layer 5a and the negative electrode capacitor layer 5b preferably further contain any of a metallic lead powder and a lead compound.

As a lead compound can be cited, for example, such monobasic lead sulfate, tribasic lead sulfate, tetrabasic lead sulfate, sulfate lead, and a lead oxide. In this connection, as a lead oxide can be cited, for example, such lead suboxide (Pb₂O), lead monoxide (PbO (including litharge and massicot)), and lead dioxide (PbO₂), and in addition, a lead (II, IV) oxide such as dilead trioxide (Pb₂O₃) and trilead tetroxide (Pb₃O₄ (including red lead)). Among others are preferable the metallic lead powder and the lead oxide.

A content of any of the metallic lead powder and the lead oxide in the positive electrode capacitor layer 5a and the negative electrode capacitor layer 5b is preferably not less than 5 mass % and not more than 75 mass %, assuming a total of activated carbon, a binder, and a conductive auxiliary agent therein to be 100 mass %.

Such the positive electrode capacitor layer 5a and the negative electrode capacitor layer 5b are, as described before, preferably bound so as to become same potentials as the positive electrode plate 1a and the negative electrode plate 6a, and are preferably something where micro porosities are formed, that is, porous bodies so that an electrolyte can move to an adhesion face between the layer 5a and the positive electrode plate 1a and that between the layer 5b and the negative electrode plate 6a. Such the positive electrode capacitor layer 5a and the negative electrode capacitor layer 5b can be obtained by setting respective contents of activated carbon, a binder, and a conductive auxiliary agent as the above mentioned ranges.

The partitions 2 avoid a contact between the positive electrode capacitor layer 5a and the negative electrode capacitor layer 5b, and a contact between the casing 7 and any of the capacitor layers 5a, 5b.

The partition 2 may be known one, and as the partition 2 can be cited, for example, a separator composed of a resin such as polyethylene and a retainer composed of a glass fiber.

Next will be described an operation of the single plate lead-acid battery Va where the positive electrode body 1 and the negative electrode body 6 related to the embodiment are built in.

In the positive electrode plate 1a of the single plate lead-acid battery Va proceeds a positive electrode reaction shown in the following chemical formula (1):

$${PbO}_{2} + 4 H + + {SO}_{{4}^{{2}^{-}}} + 2 {e}^{-} {⇄}_{Charge}^{Discharge} {PbSO}_{4} + 2 {H}_{2} O \qquad ( 1 )$$

In addition, in the negative electrode plate 6a proceeds a negative electrode reaction shown in the following chemical formula (2):

$$Pb + {SO}_{{4}^{{2}^{-}}} {⇄}_{Charge}^{Discharge} PbSO 4 + 2 {e}^{-} \qquad ( 2 )$$

In other words, in the positive electrode plate 1a in discharging, as shown in the formula (1), lead dioxide (PbO₂) of an active substance reacts with a hydrogen ion (H⁺), thereby lead sulfate (PbSO₄) is precipitated, and water (H₂O) is produced. In addition, in the positive electrode plate 1a in charging, a reverse reaction thereof proceeds.

Then in the negative electrode plate 6a in discharging, as shown in the formula (2), lead (Pb) of an active substance reacts with a sulfate ion (SO₄²⁻), thereby lead sulfate (PbSO₄) is precipitated, and an electron is discharged. In addition, in the negative electrode plate 6a in charging, a reverse reaction thereof proceeds.

In such the single plate lead-acid battery Va, the positive electrode capacitor layer 5a accelerates the reaction of the formula (1) and detaches an anion from the activated carbon in charging. As a result, to the positive electrode capacitor layer 5a is given a double layer capacitance. In addition, the positive electrode capacitor layer 5a adsorbs a cation to the activated carbon at end of discharging. As a result, to the positive electrode capacitor layer 5a is given a double layer capacitance. In other words, in the positive electrode capacitor layer 5a the active substance and activated carbon of the positive electrode plate 1a become a same potential by the binder, the double layer capacitance is given by the activated carbon, and thereby the layer 5a brings out a storage function.

On the other hand, the negative electrode capacitor layer 5b accelerates the reaction of the formula (2) and detaches a cation from the activated carbon in charging. As a result, to the negative electrode capacitor layer 5b is given a double layer capacitance. In addition, the negative electrode capacitor layer 5b adsorbs an anion to the activated carbon at end of discharging. As a result, to the negative electrode capacitor layer 5b is given a double layer capacitance. In other words, in the negative electrode capacitor layer 5b the active substance and activated carbon of the negative electrode plate 6a become a same potential by the binder, the double layer capacitance is given by the activated carbon, and thereby the layer 5b brings out a storage function.

In accordance with the single plate lead-acid battery Va thus described, because in each of the positive electrode capacitor layer 5a of the positive electrode body 1 and the negative electrode capacitor layer 5b of the negative electrode body 6 is accumulated power (an electric charge is accumulated), a higher output of the battery Va can be realized. Meanwhile, in the positive electrode capacitor layer 5a and the negative electrode capacitor layer 5b, by the activated carbon existing in each uppermost surface of the positive electrode plate 1a and the negative electrode plate 6a, the output of the single plate lead-acid battery Va becomes larger. In addition, by the activated carbon adhering to each uppermost surface of the positive electrode plate 1a and the negative electrode plate 6a without a gap, the output of the single plate lead-acid battery Va becomes larger.

In addition, in accordance with the single plate lead-acid battery Va the positive electrode capacitor layer 5a and the positive electrode plate 1a are adhered by a binder, the negative electrode capacitor layer 5b and the negative electrode plate 6a are adhered by the binder, and there exists no gap between each two. As a result, the single plate lead-acid battery Va can bring out an output higher than a lead-acid battery where an electrode plate and an activated carbon layer are not sufficiently adhered (not melted and adhered).

In addition, in the single plate lead-acid battery Va, the positive electrode capacitor layer 5a is disposed in contact with the positive electrode plate 1a, and the negative electrode capacitor layer 5b in contact with the negative electrode plate 6a. Accordingly, in accordance with the single plate lead-acid battery Va, an output can be improved without thinning each thickness of the positive electrode plate 1a, the negative electrode plate 6a, and the partitions 2 and thereby shortening a distance between the electrodes.

In addition, in the single plate lead-acid battery Va, because the positive electrode capacitor layer 5a and the negative electrode capacitor layer 5b contain a binder, they have a strong adhesion force to the positive electrode plate 1a and the negative electrode plate 6a. As a result, in the single plate lead-acid battery Va the positive electrode capacitor layer 5a and the negative electrode capacitor layer 5b can be prevented from peeling off from the positive electrode plate 1a and the negative electrode plate 6a due to an influence of a gas produced at end of charging. Accordingly, in accordance with the single plate lead-acid battery Va the higher output can be maintained.

In addition, in the single plate lead-acid battery Va, because the positive electrode capacitor layer 5a and the negative electrode capacitor layer 5b contain any of a metallic lead powder and a lead compound, an adhesion property between respective interfaces of the active substances contained in the positive electrode plate 1a and the negative electrode plate 6a and the respective layers 5a, 5b can be enhanced. As a result, an adhesion force of the positive electrode capacitor layer 5a to the positive electrode plate 1a and that of the negative electrode capacitor layer 5b to the negative electrode plate 6a are remarkably improved. Accordingly, the positive electrode capacitor layer 5a and the negative electrode capacitor layer 5b result in becoming difficult to respectively peel off from the positive electrode plate 1a and the negative electrode plate 6a due to an influence of a gas produced at end of charging, different from a layer composed of carbon only or a combination of the carbon and a dispersant. As a result, the single plate lead-acid battery Va using the positive electrode capacitor layer 5a and the negative electrode capacitor layer 5b result in bringing out a higher output.

Next will be described a manufacturing method of the single plate lead-acid battery Va.

In the manufacturing method is adjusted a capacitor layer composition matter containing the activated carbon, the binder, the conductive auxiliary agent, and any of the metallic lead powder and the lead compound (first process).

The capacitor layer composition matter can be obtained by dryly or wetly kneading each of the components. A blending ratio of each component in the capacitor layer composition matter can be set according to a content of each component in the capacitor layers 5a, 5b.

Then in a case of wetly adjusting a capacitor layer composition matter, in adding a binder, as described before, to the activated carbon, the conductive auxiliary agent, and any of the metallic lead and the lead compound are preferably added at least one (binder excellent in adhesion force) selected from polytetrafluoroethylene, ethylene-propylene rubber, styrene-butadiene rubber, chlorosulfonated polyethylene rubber, nitrile rubber, and methacrylate methyl-butadiene rubber; and a water solution of at least one (binder abounded in increasing viscosity) selected from polyvinyl alcohol, methylcellulose, carboxymethylcellulose, sodium carboxymethylcellulose, hydroxypropyl methylcellulose, hydroxymethylethylcellulose, hydroxyethylcellulose, and polyethylene oxide. In this connection the “binder excellent in adhesion force” may be dry state one or a water dispersion liquid.

In the slurry-form capacitor layer composition matter thus obtained, because a viscosity thereof can be easily adjusted, forming a capacitor layer becomes easy.

In addition, the capacitor layer composition matter becomes easily adjusted in viscosity thereof also by kneading in advance: a water solution or a water dispersion liquid of at least one binder selected from polytetrafluoroethylene, polyfluorovinylidene, polyvinyl alcohol, methylcellulose, carboxymethylcellulose, sodium carboxymethylcellulose, hydroxypropyl methylcellulose, hydroxymethylethylcellulose, hydroxyethylcellulose, polyethylene oxide, ethylene-propylene rubber, styrene-butadiene rubber, chlorosulfonated polyethylene rubber, nitrile rubber, methacrylate methyl-butadiene rubber, butyl glycol acetate, and ethyl diglycol acetate; and at least one selected from monobasic lead sulfate, tribasic lead sulfate, tetrabasic lead sulfate, sulfate lead, and a lead oxide. At this time, if a sulfuric acid-water solution is further added thereto, the capacitor layer composition matter becomes more easily adjusted in viscosity.

Next, the capacitor layer composition matter thus adjusted is extended on the positive electrode plate 1a and the negative electrode plate 6a as described above, and thereby the positive electrode capacitor layer 5a and the negative electrode capacitor layer 5b are formed (second process). At this time, in a case of the capacitor layer composition matter being wetly adjusted, it is extended on the positive electrode plate 1a and the negative electrode plate 6a by a known method such as a doctor blade method. In addition, in a case of the capacitor layer composition matter being dryly adjusted, it is dispensed to the positive electrode plate 1a and the negative electrode plate 6a, thereafter is adhered with a predetermined pressure being applied thereto, preferably heated and adhered with the pressure, and thereby is extended.

Then in the manufacturing method the positive electrode capacitor layer 5a and the negative electrode capacitor layer 5b, the positive electrode plate 1a and the negative electrode plate 6a respectively formed, and the partitions 2 are housed in the casing 7 together with an electrolyte (not shown) containing sulfuric acid (third process). Then a series of the manufacturing processes of the single plate lead-acid battery Va is finished.

### Second Embodiment

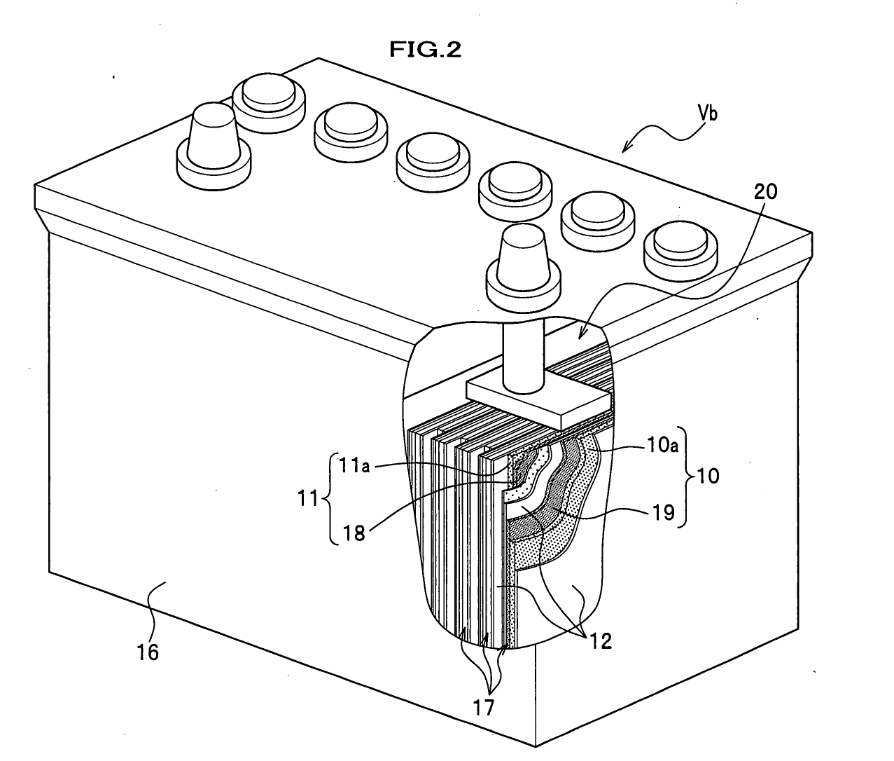

Next will be described a second embodiment of the present invention in detail, referring to a drawing as needed. Here, as an example of the present invention will be described an automobile lead-acid battery and electrode bodies built therein. In a referred drawing FIG. 2 is a perspective view illustrating a configuration of an automobile lead-acid battery where electrode bodies (lead-acid battery electrode bodies) related to the second embodiment of the present invention are built in, and is a drawing including a cutout at part of an electrolysis bath and electrode bodies.

As shown in FIG. 2, an automobile lead-acid battery Vb comprises a positive electrode body 11 (lead-acid battery electrode body) and a negative electrode body 10 (lead-acid battery electrode body). The automobile lead-acid battery Vb is configured similarly to a lead-acid battery of a battery type 38B19 except for using the positive electrode body 11 and the negative electrode body 10 instead of a positive electrode plate and a negative electrode plate in a well known automobile lead-acid battery (for example, the lead-acid battery of the battery type 38B19). In other words, in the automobile lead-acid battery Vb are disposed the positive electrode body 11 and the negative electrode body 10 through separatorsl2 composed of a resin such as polyethylene, and a group 17 composed of the negative electrode body 10, the positive electrode body 11, and the separators 12 is plurally stacked, and thereby a stacked electrode cluster 20 is formed. Then although not shown, in an electrolysis bath 16 are housed six stacked electrode clusters 20 together with an electrolyte containing sulfuric acid (H₂SO₄). In this connection, each positive electrode plate 11a described later of the positive electrode body 11 and each negative electrode plate 10a described later of the negative electrode body 10 in the stacked electrode clusters 20 are electrically connected in parallel, similarly to a positive electrode plate and a negative electrode plate of the battery type 38B19, and each of the stacked electrode clusters 20 is electrically connected in series.

The positive electrode body 11 comprises the positive electrode plate 1a and a positive electrode capacitor layer 18 formed on one side of the plate 11a; the negative electrode body 10 comprises the negative electrode plate 10a and a negative electrode capacitor layer 19 formed on one side of the plate 10a.

In the automobile lead-acid battery Vb are disposed the positive electrode body 11 and the negative electrode body 10 so that the positive electrode capacitor layer 18 and the negative electrode capacitor layer 19 face each other through the separator 12. Then the separators 12 are disposed between the positive electrode capacitor layer 18 and the negative electrode capacitor layer 19; each group 17; and the electrolysis bath 16 and outer electrode plates (the positive electrode plate 11a and the negative electrode plate 10a).

Meanwhile, each of the positive electrode plate 11a, the negative electrode plate 10a, the positive electrode capacitor layer 18, and the negative electrode capacitor layer 19 can be respectively formed with the same materials as the positive electrode plate 1a, the negative electrode plate 6a, the positive electrode capacitor layer 5a, and the negative electrode capacitor layer 5b.

In accordance with the automobile lead-acid battery Vb thus described can be obtained the same action and effect as that of the single plate lead-acid battery Va related to the first embodiment.

In addition, in the automobile lead-acid battery Vb, because the positive electrode capacitor layer 18 and the negative electrode capacitor layer 19 contain a conductive auxiliary agent, the battery Vb has a better electron conductivity. As a result, an IR loss can be reduced, compared to an automobile lead-acid battery having any one of a silica layer and fibrous activated carbon like a felt. Accordingly, in accordance with the automobile lead-acid battery Vb an extension of a discharge time can be realized even if a high rate discharge is performed.

In addition, In accordance with the automobile lead-acid battery Vb, in the positive electrode plate 11a and the negative electrode plate 10a are disposed the positive electrode capacitor layer 18 and the negative electrode capacitor layer 19 at an opposing side. In other words, the positive electrode capacitor layer 18 is disposed at a nearest side to the negative electrode plate 10a; the negative electrode capacitor layer 19 is disposed at a nearest side to the positive electrode plate 11a. On the other hand, if a lead-acid battery generally performs a high rate discharge, reactions shown in the formulas (1) and (2) proceed only at a surface layer portion of side of a positive electrode plate and a negative electrode plate opposing each other. Then, for example, if a high rate discharge is performed in such a conventional automobile lead-acid battery (for example, see the Japanese Patent Laid-Open Publication No. 2003-51306) where electrode plates where conductive carbon and activated carbon are mixed are used, ions for making the reactions shown in the formulas (1) and (2) proceed are depleted at a surface layer portion of each electrode plate. On the other hand, in the automobile lead-acid battery Vb, because the positive electrode capacitor layer 18 and the negative electrode capacitor layer 19 are respectively disposed at surface layer portions of the positive electrode plate 11a and the negative electrode plate 10a, and the layers 18, 19 do not contain an active substance and can heighten the content of activated carbon, the reactions shown in the formulas (1) and (2) can be made to rapidly proceed. As a result, in the automobile lead-acid battery Vb, when a high rate discharge is performed, a higher output can be brought out.

In addition, in the automobile lead-acid battery Vb, because even if the contents of activated carbon are reduced in the positive electrode capacitor layer 18 and the negative electrode capacitor layer 19, an output equivalent to a conventional automobile lead-acid battery (for example, see the Japanese Patent Laid-Open Publication No. 2003-51306) can be brought out, manufacturing cost can be reduced.

### Third Embodiment

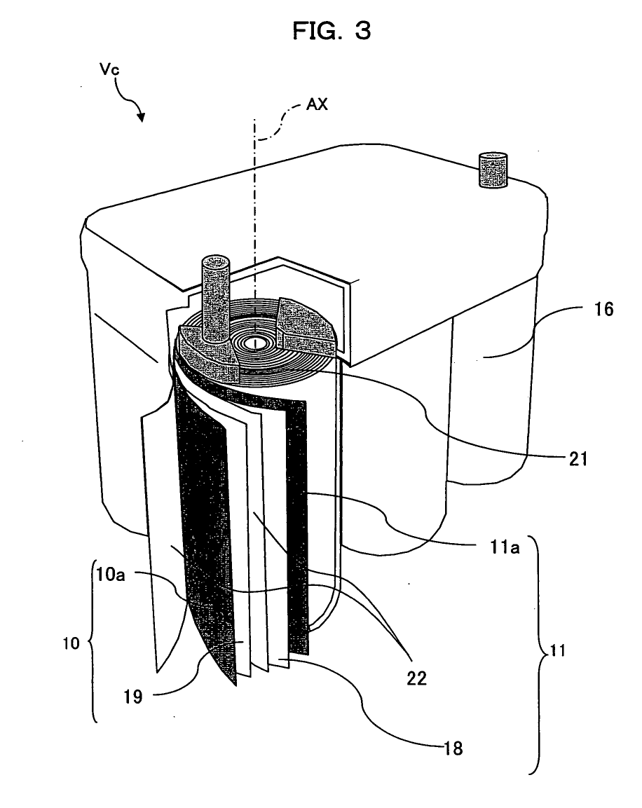

Next will be described a third embodiment of the present invention in detail, referring to a drawing as needed. Here, as an example of the present invention will be described a cylindrical lead-acid battery and electrode bodies built therein. In a referred drawing FIG. 3 is a perspective view illustrating a configuration of a cylindrical lead-acid battery where electrode bodies (lead-acid battery electrode bodies) related to the third embodiment of the present invention are built in, and is a drawing including a cutout at part of an electrolysis bath. Meanwhile, to a component similar to that of the second embodiment will be appended a same symbol, and a detailed description thereof will be omitted.

As shown in FIG. 3, a cylindrical lead-acid battery Vc comprises a positive

electrode body 11 (lead-acid battery electrode body) and a negative electrode body 10 (lead-acid battery electrode body). The cylindrical lead-acid battery Vc is configured similarly to a well known cylindrical lead-acid battery (for example, a cylindrical lead-acid battery of a battery type 38B19) except for using the positive electrode body 11 and the negative electrode body 10 instead of a positive electrode plate and a negative electrode plate in the well known cylindrical lead-acid battery. In other words, in the cylindrical lead-acid battery Vc are overlapped retainers 22 composed of a glass fiber, the negative electrode body 10, and the positive electrode body 11 so as to be a retainer 22, the body 10, a retainer 22, and the body 11 in this order; and they are wound around a predetermined center axis AX, and thus a cylindrical electrode plate cluster 21 is formed. Then although not shown, in the electrolysis bath 16 are housed six cylindrical electrode plate clusters 21 together with an electrolyte containing sulfuric acid (H₂SO₄). In this connection, each positive electrode plate 11a described later of the positive electrode body 11 and each negative electrode plate 10a described later of the negative electrode body 10 in the cylindrical electrode plate clusters 21 are electrically connected in parallel, similarly to a positive electrode plate and negative electrode plate of a conventional cylindrical lead-acid battery, and each of the cylindrical electrode plate clusters 21 is electrically connected in series.

The positive electrode body 11 comprises the positive electrode plate 11a formed like a girdle and the positive electrode capacitor layer 18 formed on one side of the plate 11a; the negative electrode body 10 comprises the negative electrode plate 10a formed like a girdle and the negative electrode capacitor layer 19 formed on one side of the plate 10a.

In the cylindrical lead-acid battery Vc are repeatedly aligned the retainer 22, the body 10, the retainer 22, and the body 11 in this order toward the central axis AX from an outer peripheral side of the cylindrical electrode plate cluster 21. In other words, in the cylindrical lead-acid battery Vc, the positive electrode body 11 and the negative electrode body 10, and the positive electrode capacitor layer 18 and the negative electrode capacitor layer 19 respectively face each other through the retainer 22.

Each of the positive electrode plate 11a, the negative electrode plate 10a, the positive electrode capacitor layer 18, and the negative electrode capacitor layer 19 can be respectively formed with the same materials as those of the positive electrode plate 1a, the negative electrode plate 6a, the positive electrode capacitor layer 5a, and the negative electrode capacitor layer 5b in the first embodiment.

In accordance with the cylindrical lead-acid battery Vc thus described can be obtained the same action and effect as those of the single plate lead-acid battery Va related to the first embodiment and the automobile lead-acid battery Vb related to the second embodiment.

In addition, in accordance with the cylindrical lead-acid battery Vc can be prevented a dendrite short. The dendrite short means to short-circuit a negative electrode plate and a positive electrode plate by a dendrite precipitated into the negative electrode plate penetrating a retainer. In other words, in accordance with the cylindrical lead-acid battery Vc a dendrite short can be prevented by the negative electrode capacitor layer 19 disposed between the negative electrode plate 10a and the retainer 22 functioning as a protective film.

In addition, in the cylindrical lead-acid battery Vc, because the positive electrode capacitor layer 18 and the negative electrode capacitor layer 19 are wound and housed in the electrolysis bath 16, surface areas of the layers 18, 19 can be ensured wider. Accordingly, in accordance with the cylindrical lead-acid battery Vc can be brought out a higher output.

### Fourth Embodiment

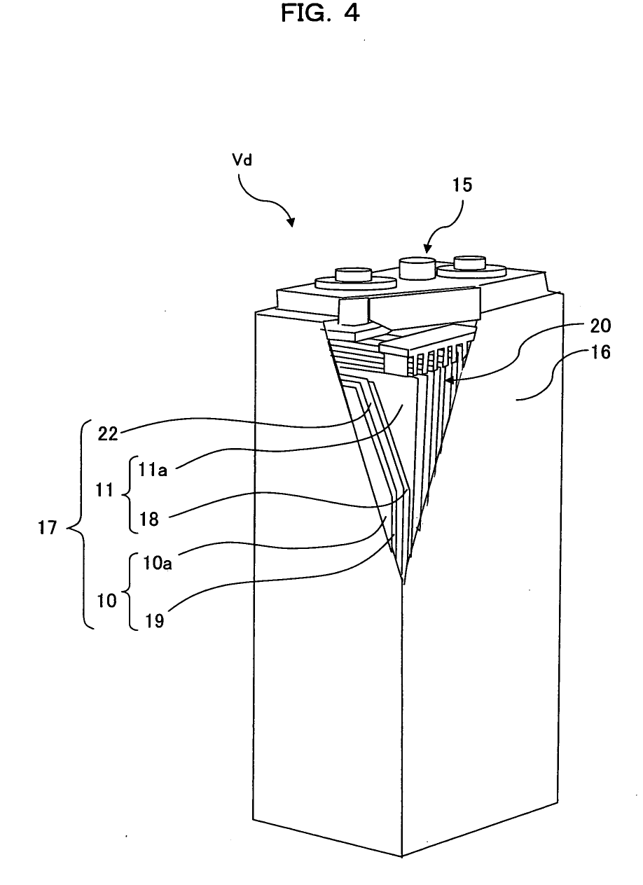

Next will be described a fourth embodiment of the present invention in detail, referring to a drawing as needed. Here, as an example of the present invention will be described a valve-regulated lead-acid battery and electrode bodies built therein. In a referred drawing FIG. 4 is a perspective view illustrating a configuration of a valve-regulated lead-acid battery where electrode bodies (lead-acid battery electrode bodies) related to the fourth embodiment of the present invention are built in, and is a drawing including a cutout at part of an electrolysis bath. Meanwhile, to a component similar to the second embodiment will be appended a same symbol, and a detailed description thereof will be omitted.

As shown in FIG. 4, a valve-regulated lead-acid battery Vd comprises the positive electrode body 11 (lead-acid battery electrode body) and the negative electrode body 10 (lead-acid battery electrode body). The valve-regulated lead-acid battery Vd is configured similarly to a well known valve-regulated lead-acid battery except for using the positive electrode body 11 and the negative electrode body 10 instead of a positive electrode plate and a negative electrode plate in the well known valve-regulated lead-acid battery. In other words, in the valve-regulated lead-acid battery Vd are disposed the positive electrode body 11 and the negative electrode body 10 through the retainer 22 composed of a glass fiber; and the group 17 composed of the body 11, the body 10, and the retainer 22 is plurally stacked, and thereby the stacked electrode cluster 20 is formed. Then although not shown, in the electrolysis bath 16 is housed the stacked electrode plate cluster 20 together with an electrolyte containing sulfuric acid (H₂SO₄). In this connection, to the valve-regulated lead-acid battery Vd is attached a control valve 15 for adjusting a pressure within the electrolysis bath 16.

The positive electrode body 11 comprises the positive electrode plate 11a and the positive electrode capacitor layer 18 formed on one side of the plate 11a; the negative electrode body 10 comprises the negative electrode plate 10a and the negative electrode capacitor layer 19 formed on one side of the plate 10a.

In the valve-regulated lead-acid battery Vd are respectively disposed the positive electrode body 11 and the negative electrode body 10, and the positive electrode capacitor layer 18 and the negative electrode capacitor layer 19, so as to face each other through the retainer 22.

Each of the positive electrode plate 11a, the negative electrode plate 10a, the positive electrode capacitor layer 18, and the negative electrode capacitor layer 19 can be respectively formed with the same materials as those of the positive electrode plate 1a, the negative electrode plate 6a, the positive electrode capacitor layer 5a, and the negative electrode capacitor layer 5b in the first embodiment.

In accordance with the valve-regulated lead-acid battery Vd thus described can be obtained the same action and effect as those of the single plate lead-acid battery Va related to the first embodiment and the automobile lead-acid battery Vb related to the second embodiment.

In addition, in accordance with the valve-regulated lead-acid battery Vd, because a pressure within the electrolysis bath 16 is adjusted by the control valve 15, vaporizing of moisture from an electrolyte can be prevented. Accordingly, in accordance with the valve-regulated lead-acid battery Vd a lead-acid battery of a higher output and a free maintenance can be provided.

### Fifth Embodiment

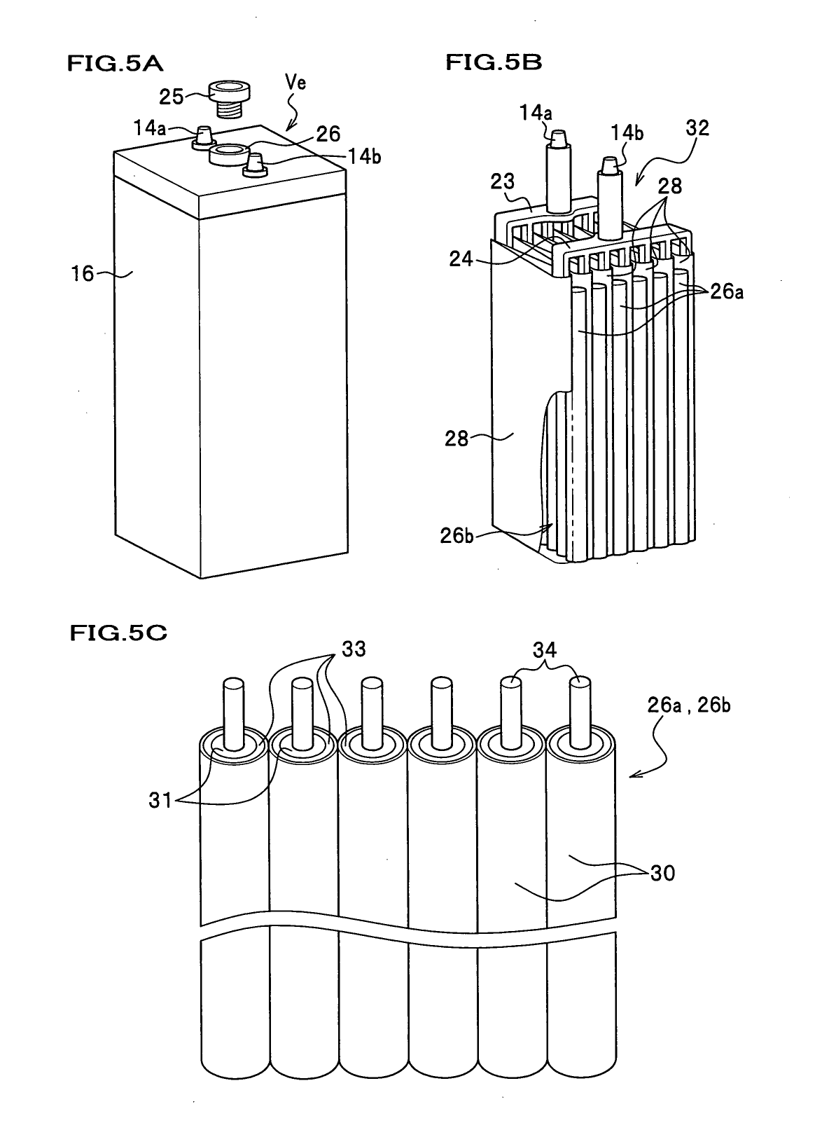

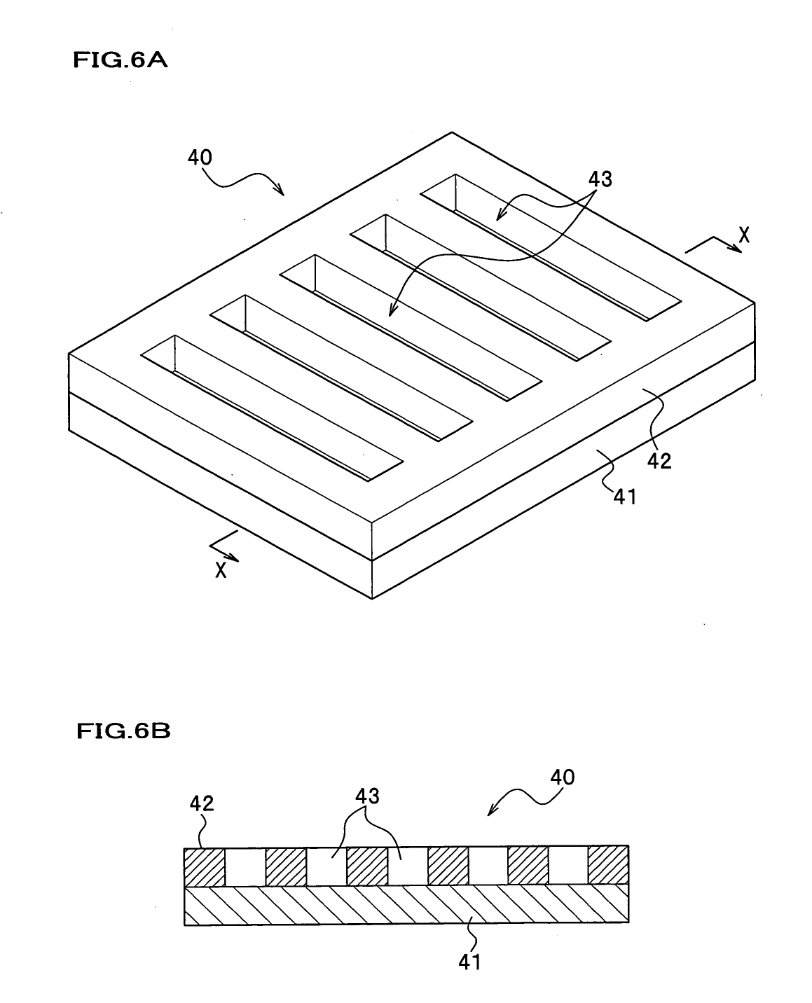

Next will be described a fifth embodiment of the present invention in detail, referring to drawings as needed. Here, as an example of the present invention will be described a tubular type lead-acid battery and electrode bodies built therein. In referred drawings FIG. 6A is an appearance perspective view of a tubular type lead-acid battery related to the fifth embodiment of the present invention; FIG. 5B is an appearance perspective view of a stacked electrode plate group configuring the tubular type lead-acid battery; and FIG. 5C is an appearance perspective view of electrode bodies (lead-acid battery electrode bodies) related to the fifth embodiment. Meanwhile, to a component similar to the second embodiment will be appended a same symbol, and a detailed description thereof will be omitted.

A tubular type lead-acid battery Ve shown in FIG. 5A is configured similarly to a well known tubular type lead-acid battery except for using positive electrode bodies 26a (see FIG. 5C) and negative electrode bodies 26b (see FIG. 5C) instead of a positive electrode plate and a negative electrode plate in the well known tubular type lead-acid battery.

As shown in FIG. 5A, the tubular type lead-acid battery Ve comprises the electrolysis bath 16 where an electrolyte filling opening 26 is formed. Then a stopper 25 for sealing the electrolyte filling opening 26 is adapted to be attachable thereto. In the electrolysis bath 16 is housed a stacked electrode plate cluster 32 shown in FIG. 5B, together with an electrolyte containing sulfuric acid (H₂SO₄). Then as shown in 5A, on an upper surface of the electrolysis bath 16 are protruded tops of a positive electrode terminal 14a and a negative electrode terminal 14b of the stacked electrode plate cluster 32 (see FIG. 5B).

As shown in FIG. 5B, in the stacked electrode plate cluster 32 each negative electrode body 26b covered with an insulating bag 28 and each positive electrode body 26a are plurally stacked so as to be alternately aligned, and thus the cluster 32 is formed.

The positive electrode body 26a and the negative electrode body 26b are, as shown in FIG. 5C, are formed like a plate, wherein a plurality of tube members 30 where each electrode portion 31 containing an active substance is filled are aligned and connected. Then between an inner wall of each tube member 30 and each electrode portion 31 is formed a capacitor layer 33 so as to melt and adhere to an outer perimeter surface of the portion 31. In addition, to the electrode portion 31 is attached an electrode ear 34 for collecting electricity. In this connection, each electrode ear 34 of the positive electrode body 26a shown in FIG. 5C is electrically connected to each other in parallel, and to the positive electrode terminal 14a through a positive electrode strap 23 shown in FIG. 5B. In addition, each electrode ear 34 of the negative electrode body 26b shown in FIG. 5C is electrically connected to each other in parallel, and to the negative electrode terminal 14b through a negative electrode strap 24 shown in FIG. 5B.

Meanwhile, the electrode portion 31 of the positive electrode plate 26a shown in FIG. 5C can be formed with the same material as that of the positive electrode plate 1a in the first embodiment; the electrode portion 31 of the negative electrode plate 26b shown in FIG. 5C can be formed with the same material as that of the negative electrode plate 6a in the first embodiment. In addition, the capacitor layer 33 can be formed with the same material as that of the positive electrode capacitor layer 5a and the negative electrode capacitor layer 5b in the first embodiment.

In accordance with the tubular type lead-acid battery Ve can be obtained the same action and effect as those of the single plate lead-acid battery Va related to the first embodiment.

In addition, in accordance with the tubular type lead-acid battery Ve, because the capacitor layer 33 is formed between the inner wall of the tube member 30 and the electrode portion 31, a melt adhesion property between the portion 31 and the capacitor layer 33 becomes better.

Meanwhile, the present invention is not limited to the embodiments and embodied by various modes.

For example, although the positive electrode capacitor layers 5a, 18 and the negative electrode capacitor layers 5b, 19 in the first to fourth embodiments and the capacitor layer 33 in the fifth embodiment are assumed to be porous, the present invention is not limited thereto; the lead-acid battery of the invention may be composed as follows: FIG. 6A is a perspective view of a lead-acid battery electrode body of another embodiment; FIG. 6B is an X-X section view of FIG. 6A.

As shown in FIGS. 6A and 6B, in accordance with a lead-acid battery electrode body 40 are formed slits 43 in a capacitor layer 42 formed on one side of the electrode plate 41. In addition, although not shown, the present invention may also comprise a capacitor layers 42 cut off like punching instead of the slits 43. In addition, a shape of the cutoff portion is not specifically limited; for example, such a circle, a rectangle, and other polygons in a plan view can be cited. In such the lead-acid battery electrode body 40 an adhesion area ratio of the capacitor layer 42 to the electrode plate 41 is preferably not less than 20% and less than 100%.

The electrode plate 41 and the capacitor layer 42 can be respectively formed with the same materials of each of the positive electrode plate 1a and the negative electrode plate 6a and each of the positive electrode capacitor layer 5a and the negative electrode capacitor layer 5b in the first embodiment.

In accordance with the lead-acid battery electrode body 40 a contact of an electrolyte with the electrode plate 41 from the side of the capacitor layer 42 becomes better.

In addition, in the first, second, and fourth embodiments, although the positive electrode capacitor layers 5a, 18 and the negative electrode capacitor layers 5b, 19 are formed on the respective one sides of the positive electrode plates 1a, 11a and the negative electrode plates 6a,10a, the present invention is not limited thereto; the layers 5a, 18 and the layers 5b, 19 may also be formed on the respective both sides of the plates 1a, 11a and the plates 6a,10a. In addition, in the present invention capacitor layers (the positive electrode capacitor layer 5a, 18 or the negative electrode capacitor layers 5b, 19) may also be formed on the positive electrode plates 1a, 11a or the negative electrode plates 6a,10a.

### EXAMPLE

Next will be more concretely described the present invention, showing examples thereof

### Examples 1 to 8

The single plate lead-acid batteries Va shown in FIG. 1 were made.

<<Making of Negative Electrode Plate>>

Firstly, adding lignin of 0.3 mass %, sulfate barium of 0.2 mass %, and carbon powders of 0.1 mass % for lead powders, and thereafter adding polyester fibers thereto, it was kneaded with a kneader for about ten minutes. Then further adding water of 12 mass % for the lead powders to the obtained mixture, and further adding dilute sulfuric acid (specific gravity 1.26 at 20 degrees Celsius) of 13 mass % for the lead powders thereto, a negative electrode active substance paste was adjusted. Filling 55 g of the negative electrode active substance paste in a collector grid of 1116 mm×100 mm×1.4 mm composed of lead-calcium-tin alloy, leaving and aging it for 18 hours under an atmosphere of temperature 50 degrees Celsius and humidity 98 RH %, and thereafter leaving and drying it for two hours at 110 degrees Celsius, the negative electrode plate 6a not conversed was made.

<<Making of Positive Electrode Plate>>

Firstly, adding polyester fibers to a mixture of lead powders and red lead, and adding water and dilute sulfuric acid (specific gravity 1.26 at 20 degrees Celsius) for the lead powders, and kneading it, a positive electrode active substance paste was adjusted. Filling 55 g of the positive electrode active substance paste in a collector grid of 1116 mm×100 mm×1.7 mm composed of lead-calcium-tin alloy, leaving and aging it for 18 hours under an atmosphere of temperature 50 degrees Celsius and humidity 98 RH %, thereafter leaving and drying it for two hours at 110 degrees Celsius, the positive electrode plate 1a not conversed was made.

<<Making of Positive Electrode Body and Negative Electrode Body>>

With respect to each example 1 to 8, weighing and blending activated carbon powders of 80 mass % having a specific surface area shown in Table 1 described later and acetylene black of 15 mass % having a specific surface area of 65 m₂/g, mixing them well, thereafter adding polytetrafluoroethylene powders of 5 mass %, and dryly kneading it, it was pulverized with a cutter-mixer. Next the obtained powder form matter was made to adhere to one side of the positive electrode plate 1a by 400 mg per one plate 1a. Pressurizing the powder form matter on the positive electrode plate 1a with a pressure of 50 MPa by hydraulic press, and thereby forming the positive electrode capacitor layer 5a on one side of the positive electrode plate 1a, the positive electrode body 1 used in each example 1 to 8 was made. Meanwhile, a ratio of an adhesion area of the positive electrode capacitor layer 5a to the one side of the positive electrode plate 1a was assumed to be 50%.

TABLE 1

| | Kind of Such Activated | Specific Surface | Discharge |
|---|---|---|---|
| | Carbon | Area (m²/g) | Time (sec) |
| Example 1 | Conifer Activated Carbon | 700 | 42 |
| Example 2 | Phenol Activated Carbon | 1100 | 48 |
| Example 3 | Phenol Activated Carbon | 1300 | 52 |
| Example 4 | Phenol Activated Carbon | 1500 | 61 |
| Example 5 | Phenol Activated Carbon | 2000 | 62 |
| Example 6 | Phenol Activated Carbon | 2500 | 62 |
| Example 7 | Phenol Activated Carbon | 3000 | 60 |
| Example 8 | Phenol Activated Carbon | 3500 | 63 |
| Comparison | — | — | 32 |
| Example 1 | | | |
| Comparison | Acetylene Black | 65 | 35 |
| Example 2 | | | |

In addition, same as in forming the positive electrode capacitor layer 5a, pressurizing the powder form matter on the negative electrode plate 6a, and thereby forming the negative electrode capacitor layer 5b on one side of the plate 6a, the negative electrode body 6 used in each example 1 to 8 was made.

Meanwhile, in forming the positive electrode capacitor layer 5a and the negative electrode capacitor layer 5b, by using a hot press instead of a hydraulic press, an adhesion property of the layers 5a, 5b to the positive electrode plate 1a and the negative electrode plate 6a is further improved. In addition, because the mass of the formed positive electrode capacitor layer 5a and negative electrode capacitor layer 5b is only around 0.7 mass % for the weight of the positive and negative electrode active substance pastes, manufacturing cost of the positive electrode body 1 and the negative electrode body 6 was reduced.

<<Making of Single Plate Lead-Acid Battery>>

Using the made positive electrode body 1 and negative electrode body 6, the single plate lead-acid battery Va was made for each example 1 to 8. As an electrolyte was dilute sulfuric acid of specific gravity 1.225 (at 20 degrees Celsius). Meanwhile, a conversion of the single plate lead-acid battery Va was performed at 2.2 A for 20 hours. Then adding dilute sulfuric acid of specific gravity 1.4 (at 20 degrees Celsius) after the conversion, the electrolyte was adjusted so as to become dilute sulfuric acid of a concentration of specific gravity 1.28 (at 20 degrees Celsius).

Then a discharge time of when the single plate lead-acid battery Va was discharged at 15 CA was measured. Meanwhile, “15 CA” is a current value that can discharge a battery capacity in one fifteenth hour, and “15 CA” corresponds to 26 A in all examples as well as comparison examples described later. Meanwhile, a measurement value of the discharge time is at 25 degrees Celsius.

### Comparison Example 1

A single plate lead-acid battery was made similarly to the single plate lead-acid battery Va of the examples 1 to 8 except for not having the positive electrode capacitor layer 5a and the negative electrode capacitor layer 5b. Then a discharge time of when the single plate lead-acid battery was discharged at 15 CA was measured. A result thereof is shown in Table 1.

### Comparison Example 2

A single plate lead-acid battery was made similarly to the single plate lead-acid battery Va of the examples 1 to 8 except for using acetylene black of 80 mass % of which a specific surface area was 65 m²/g instead of active carbon powders of 80 mass %. Then a discharge time of when the single plate lead-acid battery was discharged at 15 CA was measured. A result thereof is shown in Table 1.

<Evaluation of Discharge Performance>

As apparent from Table 1, the single plate lead-acid battery Va of the present invention comprising the positive electrode capacitor layer 5a and the negative electrode capacitor layer 5b where activated carbon having a specific surface area not less than 700 m²/g was used is long in discharge time and excellent in discharge performance when discharged at 15 CA, compared to the single plate lead-acid battery (see the comparison example 1) not comprising the layers 5a, 5b and the single plate lead-acid battery (see the comparison example 2) comprising the layers 5a, 5b not containing the activated carbon. In this connection, the single plate lead-acid battery Va (see each example 4 to 8) containing the activated carbon having a specific surface area not less than 1500 m²/g is longer in discharge time.

### Examples 9 to 18

The single plate lead-acid battery Va was made similarly to the examples 1 to 8 except for using phenol activated carbon powders of a specific surface area of 1500 m²/g and a conductive auxiliary agent shown in Table 2 described later. Then a discharge time of when the single plate lead-acid battery Va was discharged at 15 CA was measured. A result thereof is shown in Table 2.

TABLE 2

| | | Discharge Time |
|---|---|---|
| | Kind of Conductive Auxiliary Agent | (sec) |
| Example 9 | Carbon Black | 62 |
| Example 10 | Furnace Black | 60 |
| Example 11 | Natural Graphite | 57 |
| Example 12 | Artificial Graphite | 58 |
| Example 13 | Isotropic Graphite | 56 |
| Example 14 | Mesophase Graphite | 60 |
| Example 15 | Pitch Carbon Fiber | 61 |
| Example 16 | Vapor Phase Epitaxy Carbon Fiber | 63 |
| Example 17 | Nanocarbon | 62 |
| Example 18 | PAN Carbon Fiber | 60 |
| Comparison | — | 45 |
| Example 3 | | |

### Comparison Example 3

A single plate lead-acid battery was made similarly to the examples 1 to 8 except for using phenol activated carbon powders of 15 mass % of which a specific surface area was 1500 m²/g instead of the conductive auxiliary agent of 15 mass % in Table 2. Then a discharge time of when the single plate lead-acid battery was discharged at 15 CA was measured. A result thereof is shown in Table 2.

<Evaluation of Discharge Performance>

As apparent from Table 2, the single plate lead-acid battery Va of the present invention comprising the positive electrode capacitor layer 5a and the negative electrode capacitor layer 5b where the conductive auxiliary agent was used is long in discharge time and excellent in discharge performance when discharged at 15 CA, compared to the single plate lead-acid battery (see the comparison example 3) comprising the layers 5a, 5b not containing the conductive auxiliary agent.

### Examples 19-35

The single plate lead-acid battery Va was made similarly to the examples 1 to 8 except for using phenol activated carbon powders of 70 mass % of which a specific surface area was 1500 m²/g, acetylene black of 20 mass % of which a specific surface area was 65 m²/g, and a binder of 10 mass % (as a solid content) shown in Table 3 described later. Then a discharge time of when the single plate lead-acid battery Va was discharged at 15 CA was measured. A result thereof is shown in Table 3. Meanwhile, as a reference the discharge time in the comparison example 1 is written together.

TABLE 3

| | | Discharge |
|---|---|---|
| | Kind of Binder | Time (sec) |
| Example 19 | Polytetrafluoroethylene | 61 |
| Example 20 | Polyfluorovinylidene | 60 |
| Example 21 | Polyvinyl Alcohol | 59 |
| Example 22 | Methylcellulose | 58 |
| Example 23 | Carboxymethylcellulose | 59 |
| Example 24 | Sodium Carboxymethylcellulose | 60 |
| Example 25 | Hydroxypropyl Methylcellulose | 62 |
| Example 26 | Hydroxyethylmethylcellulose | 61 |
| Example 27 | Hydroxyethylcellulose | 60 |
| Example 28 | Polyethylene Oxide | 57 |
| Example 29 | Ethylene-Propylene Rubber | 58 |
| Example 30 | Styrene-Butadiene Rubber | 56 |
| Example 31 | Chlorosulfonated Polyethylene Rubber | 57 |
| Example 32 | Nitrile Rubber | 60 |
| Example 33 | Methacrylate Methyl-Butadiene Rubber | 59 |
| Example 34 | Butyl Glycol Acetate | 58 |
| Example 35 | Ethyl Diglycol Acetate | 58 |
| Comparison | — | 32 |
| Example 1 | | |

<Evaluation of Discharge Performance>

As apparent from Table 3, the single plate lead-acid battery Va of the example 19 where polytetrafluoroethylene powders were used as a binder is long in discharge time and excellent in discharge performance when discharged at 15 CA, compared to the single plate lead-acid battery (see the comparison example 1) not comprising the positive electrode capacitor layer 5a and the negative electrode capacitor layer 5b. Then compared to the single plate lead-acid battery Va of the example 19, the battery Va of the examples 20 to 35 is long in discharge time and excellent in discharge performance to same extent.

### Examples 36 to 44

The single plate lead-acid battery Va was made similarly to the examples 1 to 8 except for not only using phenol activated carbon powders of a specific surface area of 1500 m²/g, a conductive auxiliary agent, an a binder in combination as shown in Table 4 described later but also adding the carbon powders of 70 mass %, the conductive auxiliary agent of 15 mass %, and the binder of 10 mass % (as a solid content). Then a discharge time of when the single plate lead-acid battery Va was discharged at 15 CA was measured. A result thereof is shown in Table 4.

TABLE 4

| | | Kind of | | Dis- |
|---|---|---|---|---|
| | Kind of | Conductive | | charge |
| | Activated | Auxiliary | | Time |
| | Carbon | Agent | Kind of Binder | (sec) |
| Example 36 | Phenol | Acetylene | Polyvinyl Alcohol | 61 |
| Example 37 | Activated | Black | Hydroxyethylcellulose | 62 |
| Example 38 | Carbon | | Styrene-Butadiene | 57 |
| | (1500 | | Rubber | |
| Example 39 | m²/g) | Natural | Polyvinyl Alcohol | 60 |
| Example 40 | | Graphite | Hydroxyethylcellulose | 56 |
| Example 41 | | | Styrene-Butadiene | 58 |
| | | | Rubber | |
| Example 42 | | Vapor | Polyvinyl Alcohol | 57 |
| Example 43 | | Phase | Hydroxyethylcellulose | 59 |
| Example 44 | | Epitaxy | Styrene-Butadiene | 61 |
| | | Carbon | Rubber | |

<Evaluation of Discharge Performance>

Also the single plate lead-acid battery Va where the phenol activated carbon, the conductive auxiliary agent, and the binder were used in combination shown in Table 4 is longer in discharge time and more excellent in discharge performance.

### Examples 45 to 48

Mixing phenol activated carbon powders of 60 mass % of which a specific surface area was 1500 m²/g, acetylene black of 15 mass % of which a specific surface area was 65 m²/g, and a “binder 1” of 10 mass % (as a solid content) and a “binder 2” of 15 mass % (as a solid content) as shown in Table 5 described later, a capacitor layer composition matter was adjusted. At this time the “binder 2” was mixed as a water solution thereof. As a result, a viscosity of the capacitor layer composition matter could be adjusted. Next, coating the capacitor layer composition matter on respective one sides of the positive electrode plate 1a and the negative electrode plate 6a used in each example 1 to 8, the positive electrode body 1 and the negative electrode body 6 respectively comprising the capacitor layers 5a, 5b were made. At this time, because the viscosity of the capacitor layer composition matter could be adjusted, making the positive electrode body 1 and the negative electrode body 6 was easier.

The single plate lead-acid battery Va was made similarly to the examples 1 to 8 except for using the positive electrode body 1 and the negative electrode body 6. Then a discharge time of when the single plate lead-acid battery Va was discharged at 15 CA was measured. A result thereof is shown in Table 5.

TABLE 5

| | | | Dis- |
|---|---|---|---|
| | | | charge |
| | | | Time |
| | Kind of Binder 1 | Kind of Binder 2 | (sec) |
| Example 45 | Polytetrafluoroethylene | Hydroxyethylcellulose | 58 |
| Example 46 | | Polyvinyl Alcohol | 57 |
| Example 47 | Styrene-Butadiene | Hydroxyethylcellulose | 59 |
| Example 48 | Rubber | Polyvinyl Alcohol | 59 |

<Evaluation of Discharge Performance>

In each example 45 to 48, using two kinds of the “binder 1” and the “binder 2” as a binder, and adding the “binder 2” as a water solution thereof, the slurry-form capacitor layer composition matter was adjusted. In other words, the capacitor layer composition matter was adjusted by each composition being dryly mixed.

As apparent from Table 5, the single plate lead-acid battery Va of each example 45 to 48 thus obtained is longer in discharge time and more excellent in discharge performance when discharged at 15 CA.

### Examples 49 to 54

Adding and mixing styrene-butadiene rubber of 10 mass % (as a solid content) as a binder and polyvinyl alcohol of 15 mass % as a water solution thereof to/with coconut husk activated carbon powders of a specific surface area of 1500 m²/g and acetylene black of a specific surface area of 65 m²/g, a capacitor layer composition matter was adjusted. In this connection, a blending ratio of the coconut husk activated carbon powders and that of the acetylene black are described as “Ratio of Conductive Auxiliary Agent” and “Ratio of Activated Carbon” in Table 6.

The single plate lead-acid battery Va was made similarly to the examples 45 to 48 except for using such the capacitor layer composition matter. Then a discharge time of when the single plate lead-acid battery Va was discharged at 15 CA was measured. A result thereof is shown in Table 6. Meanwhile, as a reference the discharge time in the comparison example 1 is written together.

TABLE 6

| | Ratio of Conductive | | Discharge |
|---|---|---|---|
| | Auxiliary Agent | Ratio of Activated | Time |
| | (mass %) | Carbon (mass %) | (sec) |
| Example 49 | 15 | 75 | 58 |
| Example 50 | 5 | 85 | 56 |
| Example 51 | 30 | 60 | 57 |
| Example 52 | 50 | 40 | 48 |
| Example 53 | 80 | 10 | 43 |
| Example 54 | 90 | 0 | 33 |
| Comparison | — | — | 32 |
| Example 1 | | | |

<Evaluation of Discharge Performance>

As apparent from Table 6, the single plate lead-acid battery Va comprising the capacitor layers 5a, 5b containing the conductive auxiliary agent not less than 5 mass % and not more than 80-mass % is long in discharge time and excellent in discharge performance when discharged at 15 CA, compared to the single plate lead-acid battery of the comparison example 1. In addition, the single plate lead-acid battery Va containing the conductive auxiliary agent not less than 5 mass % and not more than 30-mass % (see the examples 49 to 51) is longer in discharge time and more excellent in discharge performance.

### Examples 55 to 61

The single plate lead-acid battery Va was made similarly to the examples 1 to 8 except for using coconut husk activated carbon powders of a specific surface area of 1500 m²/g, styrene-butadiene rubber and polyvinyl alcohol as a binder, and furnace black, and containing the coconut husk activated carbon powders and the binder by ratios shown in Table 7 described later and the furnace black of 15 mass %. Meanwhile, the ratio of the binder shows a total amount (as a solid content) of the styrene-butadiene rubber and the polyvinyl alcohol. Then an initial discharge time of when the single plate lead-acid battery Va was discharged at 15 CA (hereinafter simply referred to as “initial discharge time”) and a discharge time of when the battery Va was discharged at 15 CA after discharge and charge were repeated ten times (hereinafter simply referred to as “discharge time after ten cycles) were measured. A result thereof is shown in Table 7. Meanwhile, as a reference the discharge time and a discharge time after ten cycles in the comparison example 1 are written together in Table 7.

TABLE 7

| | | Ratio of | | Discharge |
|---|---|---|---|---|
| | Ratio of | Activated | Initial | Time After |
| | Binder | Carbon | Discharge | Ten Cycles |
| | (mass %) | (mass %) | Time (sec) | (sec) |
| Example 55 | 15 | 80 | 61 | 55 |
| Example 56 | 1 | 84 | 55 | 47 |
| Example 57 | 3 | 82 | 56 | 53 |
| Example 58 | 10 | 75 | 51 | 50 |
| Example 59 | 30 | 55 | 43 | 44 |
| Example 60 | 50 | 35 | 35 | 43 |
| Example 61 | 70 | 15 | 34 | 40 |
| Comparison | — | — | 32 | 30 |
| Example 1 | | | | |

<Evaluation of Discharge Performance>

As apparent from Table 7, the single plate lead-acid battery Va (see the examples 55 to 60) where the ratio of the binder is not less than 1 mass % and not more than 50 mass % is long in initial discharge time and discharge time after ten cycles and excellent in discharge performance, compared to the single plate lead-acid battery of the comparison example 1. In addition, the single plate lead-acid battery Va (see the examples 55 and 57 to 59) where the ratio of the binder is not less than 3 mass % and not more than 30 mass % is more excellent in discharge performance.

### Examples 62 to 66

The positive electrode body 1 and the negative electrode body 6, where the capacitor layers 5a, 5b were respectively formed, were made similarly to the examples 1 to 8 except for using phenol activated carbon powders of 80 mass % of which a specific surface area was 1500 m²/g, acetylene black of 15 mass % of which a specific surface area was 65 m²/g, and polytetrafluoroethylene of 5 mass % (as a solid content). Then to the positive electrode body 1 and the negative electrode body 6 was dispensed a heat treatment for ten minutes at a temperature shown in Table 8 described later. Using the positive electrode body 1 and the negative electrode body 6, the single plate lead-acid battery Va was made. Then in the single plate lead-acid battery Va the initial discharge time and the discharge time after ten cycles were measured. A result thereof is shown in Table 8.

TABLE 8

| | Heat Treatment | | Discharge Time |
|---|---|---|---|
| | Temperature | Initial Discharge | After Ten Cycles |
| | (Degree Celsius) | Time (sec) | (sec) |
| Example 62 | — | 61 | 55 |
| Example 63 | 150 | 60 | 52 |
| Example 64 | 200 | 68 | 59 |
| Example 65 | 350 | 67 | 59 |
| Example 66 | 400 | 42 | 43 |

<Evaluation of Discharge Performance>

As apparent from Table 8, the single plate lead-acid battery Va of which the positive electrode body 1 and the negative electrode body 6 were heat-treated at a temperature not less than 200 and not more than 350 degrees Celsius is long both in initial discharge time and discharge time after ten cycles and excellent in discharge performance, compared to those (examples 62, 63) of which the body 1 and the body 6 were heat-treated at a temperature less than 200 degrees Celsius or that (example 66) of which the body 1 and the body 6 were heat-treated at a temperature more than 350 degrees Celsius.

### Examples 67 to 70

The single plate lead-acid battery Va was made similarly to the examples 1 to 8 except for using phenol activated carbon powders of 80 mass % of which a specific surface area was 1500 m²/g, acetylene black of 15 mass % of which a specific surface area was 65 m²/g, and polytetrafluoroethylene of 5 mass % (as a solid content), and setting a ratio of the adhesion area of each capacitor layer 5a, 5b to each one side of the positive electrode plate 1a and the negative electrode plate 6a as shown in Table 9 described later. Then a discharge time of when the single plate lead-acid battery Va was discharged at 15 CA was measured. A result thereof is shown in Table 9. Meanwhile, as a reference the discharge time in the comparison example 1 is written together.

TABLE 9

| | Ratio of Adhesion | |
|---|---|---|
| | Area | Discharge Time |
| | (%) | (sec) |
| Example 67 | 50 | 61 |
| Example 68 | 100 | 48 |
| Example 69 | 20 | 55 |
| Example 70 | 10 | 38 |
| Comparison Example 1 | 0 | 32 |

<Evaluation of Discharge Performance>

As apparent from Table 9, the single plate lead-acid battery Va (see the examples 67 to 69) where the ratio of the adhesion area of each capacitor layer 5a, 5b to each one side of the positive electrode plate 1a and the negative electrode plate 6a is not less than 20% and less than 100% is longer in discharge time and more excellent in discharge performance.

### Examples 71 to 87

The single plate lead-acid battery Va was made similarly to the examples 1 to 8 except for using coconut husk activated carbon powders of 45 mass % of which a specific surface area was 1500 m²/g and acetylene black of 15 mass % of which a specific surface area was 65 m²/g, styrene-butadiene rubber of 10 mass %, and “lead and a lead compound” of 30 mass % (conversion to a total amount in not less than two kinds of Table 10) shown in Table 10 described later.

Then a discharge time of when the single plate lead-acid battery Va was discharged at 15 CA was measured. A result thereof is shown in Table 10. Meanwhile, as a reference the discharge time in the comparison example 1 is written together.

TABLE 10

| | Lead and Kind of Lead | Discharge |
|---|---|---|
| | Compound | Time (sec) |
| Example 71 | Metal Lead | 59 |
| Example 72 | Monobasic Lead Sulfate | 62 |
| Example 73 | Tribasic Lead Sulfate | 58 |
| Example 74 | Tetrabasic Lead Sulfate | 57 |
| Example 75 | Sulfate Lead | 60 |
| Example 76 | Red Lead | 63 |
| Example 77 | Lead Oxide | 70 |
| Example 78 | Lead Monoxide (Litharge) | 68 |
| Example 79 | Lead Monoxide (Massicot) | 67 |
| Example 80 | Lead Dioxide | 59 |
| Example 81 | Metal Lead and Sulfate Lead | 75 |
| Example 82 | Monobasic Lead Sulfate and | 77 |
| | Red Lead | |
| Example 83 | Tribasic Lead Sulfate and | 72 |
| | Red Lead | |
| Example 84 | Tetrabasic Lead Sulfate and | 74 |
| | Red Lead | |
| Example 85 | Lead Dioxide and Lead | 78 |
| | Sulfate | |
| Example 86 | Lead Monoxide and Basic | 70 |
| | Lead Sulfate | |
| Example 87 | Lead Monoxide, Lead | 69 |
| | Dioxide, and Lead Sulfate | |
| Comparison Example 1 | — | 32 |

<Evaluation of Discharge Performance>

As apparent from Table 10, the single plate lead-acid battery Va comprising the capacitor layers 5a, 5b containing lead and the lead compound is longer in discharge time and more excellent in discharge performance.

### Example 88

The single plate lead-acid battery Va shown in FIG. 1 was made.

<<Making of Negative Electrode Plate>>

Firstly, adding lignin of 0.3 mass %, sulfate barium of 0.2 mass %, and carbon powders of 0.1 mass % for lead powders, and thereafter adding polyester fibers thereto, it was kneaded for about ten minutes with a kneader. Then adding water of 12 mass % for the lead powders to the obtained mixture, and further adding dilute sulfuric acid (specific gravity 1.26 at 20 degrees Celsius) of 13 mass % for the lead powders, a negative electrode active substance paste was adjusted. Filling 55 g of the negative electrode active substance paste in a collector grid of 1116 mm×100 mm×1.4 mm composed of lead-calcium-tin alloy, leaving and aging it for 18 hours under an atmosphere of temperature 50 degrees Celsius and humidity 98 RH %, and thereafter leaving and drying it for two hours at 110 degrees Celsius, the negative electrode plate 6a not conversed was made.

<<Making of Positive Electrode Plate>>

Firstly, adding polyester fibers to a mixture of lead powders and red lead, and further adding water and dilute sulfuric acid (specific gravity 1.26, at 20 degrees Celsius) to the lead powders, and kneading it, a positive electrode active substance paste was adjusted. Filling 55 g of the positive electrode active substance paste in a collector grid of 1116 mm×100 mm×1.7 mm composed of lead-calcium-tin alloy, leaving and aging it for 18 hours under an atmosphere of temperature 50 degrees Celsius and humidity 98 RH %, and thereafter leaving and drying it for two hours at 110 degrees Celsius, the positive electrode plate 1a not conversed was made.

<<Making of Positive Electrode Body and Negative Electrode Body>>

Weighing and blending phenol activated carbon powders of 80 mass % of which a specific surface area is 1300 m²/g and acetylene black of 15 mass % of which a specific surface area is 65 m²/g, mixing them well, thereafter adding polytetrafluoroethylene powders of 5 mass %, and dryly kneading it, it was pulverized with a cutter-mixer. Next the obtained powder form matter was adhered to one side of the positive electrode plate 1a by 400 mg per one plate 1a. Pressurizing the powder form matter on the positive electrode plate 1a with a pressure of 50 MPa by hydraulic press, and thereby forming the positive electrode capacitor layer 5a on one side of the positive electrode plate 1a, the positive electrode body 1 was made.

In addition, same as in forming the positive electrode capacitor layer 5a, pressurizing the powder form matter on the negative electrode plate 6a, and thereby forming the negative electrode capacitor layer 5b on one side of the plate 6a, the negative electrode body 6 was made.

Meanwhile, in forming the positive electrode capacitor layer 5a and the negative electrode capacitor layer 5b, by using a hot press instead of a hydraulic press, the adhesion property of the layers 5a and 5b to the positive electrode plate 1a and the negative electrode plate 6a is further improved. In addition, because masses of the formed positive electrode capacitor layer 5a and negative electrode capacitor layer 5b are only around 0.7 mass % for weights of the positive and negative electrode active substance pastes, the manufacturing cost of the positive electrode body 1 and the negative electrode body 6 was reduced.

<<Making of Single Plate Lead-Acid Battery>>

Using the made positive electrode body 1 and negative electrode body 6, the single plate lead-acid battery Va shown in FIG. 1 was made. As an electrolyte was used dilute sulfuric acid of specific gravity 1.225 (at 20 degrees Celsius). Meanwhile, the conversion of the single plate lead-acid battery Va was performed at 2.2 A for 20 hours. Then adding dilute sulfuric acid of specific gravity 1.4 (at 20 degrees Celsius) after the conversion, the electrolyte was adjusted so as to become dilute sulfuric acid of a concentration of specific gravity 1.28 (at 20 degrees Celsius). A battery capacity of the obtained single plate lead-acid battery Va was 1.75 Ah (Ampere hour), and an average discharge voltage thereof was 2V.

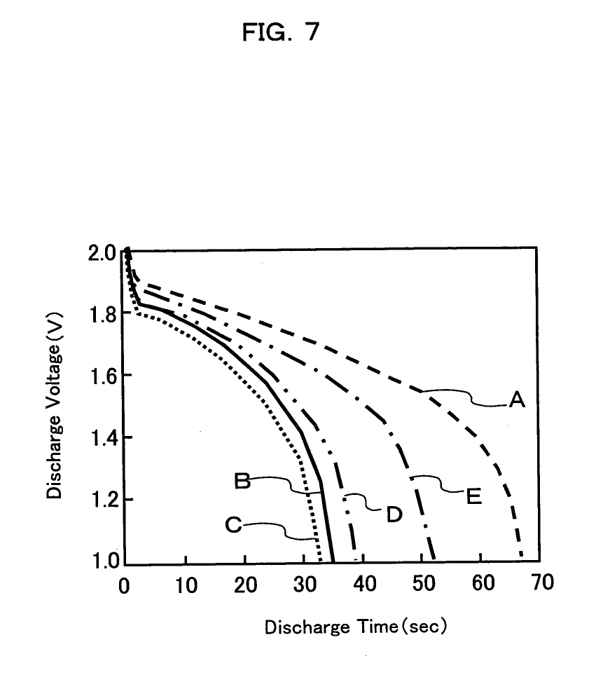

Then the single plate lead-acid battery Va was discharged at 15 CA. A discharge curve at this time is shown as A in FIG. 7.

### Comparison Example 4

A single plate lead-acid battery was made similarly to the single plate lead-acid battery Va of the example 88 except for not comprising the positive electrode capacitor layer 5a and the negative electrode capacitor layer 5b. Then the single plate lead-acid battery was discharged at 15 CA (26 A). A discharge curve at this time is shown as B in FIG. 7.

### Comparison Example 5

A single plate lead-acid battery was made similarly to the single plate lead-acid battery Va of the example 88 except for respectively forming activated carbon layers consisting of phenol activated carbon powders, of which a specific surface area was 1500 m²/g, on one sides of the positive electrode plate 1a and the negative electrode plate 6a instead of the positive electrode capacitor layer 5a and the negative electrode capacitor layer 5b. Then the single plate lead-acid battery was discharged at 15 CA (26 A). A discharge curve at this time is shown as C in FIG. 7.

### Comparison Example 6

A single plate lead-acid battery was made similarly to the single plate lead-acid battery Va of the example 88 except for respectively forming activated carbon layers consisting of acetylene black, of which a specific surface area was 65 m²/g, on one sides of the positive electrode plate 1a and the negative electrode plate 6a instead of the positive electrode capacitor layer 5a and the negative electrode capacitor layer 5b. Then the single plate lead-acid battery was discharged at 15 CA (26 A). A discharge curve at this time is shown as D in FIG. 7.

### Comparison Example 7

A single plate lead-acid battery was made similarly to the single plate lead-acid battery Va of the example 88 except for: not comprising the positive electrode capacitor layer 5a and the negative electrode capacitor layer 5b; and using as a negative electrode active substance paste a paste into which phenol activated carbon powders of which a specific surface area was 1500 m²/g and acetylene black of which a specific surface area was 65 m²/g were kneaded. Then the single plate lead-acid battery was discharged at 15 CA (26 A). A discharge curve at this time is shown as E in FIG. 7.

<Evaluation of Discharge Voltage and Discharge Performance>

As shown in FIG. 7, the single plate lead-acid battery Va of the example 88 is proved to be higher in discharge voltage and also longer in discharge time (see the discharge curve A).

In contrast, each single plate lead-acid battery of the comparison examples 1 to 7 is lower in discharge voltage and also shorter in discharge time than the single plate lead-acid battery Va of the example 88.

### Example 89

The automobile lead-acid battery Vb shown in FIG. 2 was made. The positive electrode body 1 and the negative electrode body 6 made in the example 88 were respectively used as the positive electrode body 11 and the negative electrode body 10 shown in FIG. 2. Then as the separators 12 were used something made of a polyethylene resin. Then as the stacked electrode plate cluster 20 were used five negative electrode bodies 10 and four positive electrode bodies 11. In addition, total ten separators 12, that is, eight disposed between the positive electrode bodies 11 and the negative electrode bodies 10 and two disposed between the two bodies 11, 10 and the casing were used in the stacked electrode plate cluster 20. As an electrolyte was used dilute sulfuric acid of specific gravity 1.25 (at 20 degrees Celsius). Meanwhile, the conversion of the automobile lead-acid battery Vb was performed at 9 A for 20 hours. Then adding dilute sulfuric acid of specific gravity 1.4 (at 20 degrees Celsius), the electrolyte was adjusted so as to become dilute sulfuric acid of specific gravity 1.28 (at 20 degrees Celsius). The battery capacity of the obtained automobile lead-acid battery Vb was 28 Ah and an average discharge voltage thereof was 12 V.

Then a discharge time of when the automobile lead-acid battery Vb was discharged at 15 CA, and a discharge voltage at tenth second after the discharge started were measured. A result thereof is shown in Table 11. Meanwhile, in Table 11 “a discharge voltage at tenth second after the discharge started” is abbreviated as “Tenth Second Discharge Voltage” (hereinafter same as this).

### Example 90

The cylindrical lead-acid battery Vc shown in FIG. 3 was made.

<<Making of Negative Electrode Plate>>

Firstly, similarly to the example 88, a negative electrode active substance paste was adjusted. Next, filling 275 g of the negative electrode active substance paste in a collector grid of 1116 mm×100 mm×0.7 mm composed of lead-tin alloy, leaving and aging it for 18 hours under an atmosphere of temperature 50 degrees Celsius and humidity 98 RH %, and thereafter leaving and drying it for two hours at 110 degrees Celsius, the negative electrode plate 10a was made.

<<Making of Positive Electrode Plate>>

Firstly, similarly to the example 88, a positive electrode active substance paste was adjusted. Filling 220 g of the positive electrode active substance paste in a collector grid of 1116 mm×100 mm×0.7 mm composed of lead-tin alloy, leaving and aging it for 18 hours under an atmosphere of temperature 50 degrees Celsius and humidity 98 RH %, thereafter leaving and drying it for two hours at 110 degrees Celsius, the positive electrode plate 11a was made.

<<Making of Positive Electrode Body and Negative Electrode Body>>

Weighing and blending coconut husk activated carbon powders of 80 mass % of which a specific surface area is 1700 m2/g and carbon black of 15 mass % of which a specific surface area is 1050 m2/g, mixing them well, and thereafter adding a dispersion of polytetrafluoroethylene of 3 mass % so that the addition amount becomes 5 mass % as a solid content of polytetrafluoroethylene, it was dryly kneaded. Next the obtained kneaded matter of 1.6 g was coated on one side of the positive electrode plate 11a by using a doctor blade. Then drying the kneaded matter on the positive electrode plate 11a at 200 degrees Celsius for 20 minutes, thereafter pressurizing the matter with a roll press, and thereby forming the positive electrode capacitor layer 18 on the one side of the positive electrode plate 11a, the positive electrode body 11 was made.

In addition, same as in forming the positive electrode capacitor layer 18, pressurizing the kneaded matter on the negative electrode plate 10a, and thereby forming the negative electrode capacitor layer 19 on one side of the plate 10a, the negative electrode body 10 was made.

Meanwhile, in forming the positive electrode capacitor layer 18 and the negative electrode capacitor layer 19, by using a hot press instead of the roll press, an adhesion property of the layers 18 and 19 to the positive electrode plate 11a and the negative electrode plate 10a is further improved. In addition, because masses of the formed positive electrode capacitor layer 18 and negative electrode capacitor layer 19 are only 0.6 to 0.7 mass % for weights of the positive and negative electrode active substance pastes, the manufacturing cost of the positive electrode body 11 and the negative electrode body 10 was reduced.

<<Making of Cylindrical Lead-Acid Battery>>

Using the made positive electrode body 11 and negative electrode body 10 and the retainers 22 of thickness 0.6 mm composed of a glass fiber, the cylindrical lead-acid battery Vc shown in FIG. 3 was made. As an electrolyte was used dilute sulfuric acid of specific gravity 1.28 (at 20 degrees Celsius). Meanwhile, adding dilute sulfuric acid of specific gravity 1.4 (at 20 degrees Celsius) after the conversion of the cylindrical lead-acid battery Vc, the electrolyte was adjusted so as to become dilute sulfuric acid of a concentration of specific gravity 1.28 (at 20 degrees Celsius). A battery capacity of the obtained cylindrical lead-acid battery Vc was 16 Ah, and an average discharge voltage thereof was 12V.

Then a discharge time and tenth second discharge voltage of when the cylindrical lead-acid battery Vc was discharged at 15 CA were measured. A result thereof is shown in Table 11.

### Example 91

The valve-regulated lead-acid battery Vd shown in FIG. 4 was made.

<<Making of Negative Electrode Plate and Positive Electrode Plate>>

The negative electrode plate 10a and the positive electrode plate 11a were made similarly to the negative electrode plate 6a and the positive electrode plate 1a in the example 1 except for a collector grid size being 1240 mm×140 mm×4.2 mm.

<<Making of Positive Electrode Body and Negative Electrode Body>>

Weighing and blending phenol activated carbon powders of 77 mass % of which a specific surface area is 3000 m²/g and furnace black of 15 mass % of which a specific surface area is 350 m²/g, mixing them well, and thereafter adding to it: a dispersion of styrene-butadiene rubber of 3 mass % so that the addition amount becomes 5 mass % as a solid content of styrene-butadiene rubber; and a hydroxyethylcellulose water solution of 1 mass % so that the addition amount becomes 3 mass % as a solid content of hydroxyethylcellulose, it was dryly kneaded. Next, the obtained kneaded matter of 1.6 g was coated on one side of the positive electrode plate 11a by using a doctor blade. Then drying the kneaded matter on the positive electrode plate 11a at 200 degrees Celsius for 20 minutes, thereafter pressurizing the matter with a roll press, and thereby forming the positive electrode capacitor layer 18 on the one side of the positive electrode plate 11a, the positive electrode body 11 was made.

In addition, same as in forming the positive electrode capacitor layer 18, pressurizing the kneaded matter on the negative electrode plate 10a, and thereby forming the negative electrode capacitor layer 19 on one side of the plate 10a, the negative electrode body 10 was made.

Meanwhile, in forming the positive electrode capacitor layer 18 and the negative electrode capacitor layer 19, by using a hot press instead of the roll press, the adhesion property of the layers 18 and 19 to the positive electrode plate 11a and the negative electrode plate 10a is further improved. In addition, because masses of the formed positive electrode capacitor layer 18 and negative electrode capacitor layer 19 are only 0.1 to 0.2 mass % for weights of the positive and negative electrode active substance pastes, the manufacturing cost of the positive electrode body 11 and the negative electrode body 10 was reduced.

<<Making of Valve-Regulated Lead-Acid Battery>>

Using the made positive electrode body 11 and negative electrode body 10 and the retainers 22 composed of a glass fiber, the valve-regulated lead-acid battery Vd shown in FIG. 4 was made. In the stacked electrode plate cluster 20 were used nine negative electrode bodies 10 and eight positive electrode bodies 11. In addition, in the stacked electrode plate cluster 20 were used sixteen retainers 22 disposed between the negative electrode bodies 10 and the positive electrode bodies 11. As an electrolyte was used dilute sulfuric acid of specific gravity 1.28 (at 20 degrees Celsius). Meanwhile, adding dilute sulfuric acid of specific gravity 1.4 (at 20 degrees Celsius) after the conversion of the valve-regulated lead-acid battery Vd, the electrolyte was adjusted so as to become dilute sulfuric acid of a concentration of specific gravity 1.32 (at 20 degrees Celsius). A battery capacity of the obtained valve-regulated lead-acid battery Vd was 200 Ah, and an average discharge voltage thereof was 2V.

Then a discharge time and tenth second discharge voltage of when the valve-regulated lead-acid battery Vd was discharged at 15 CA were measured. A result thereof is shown in Table 11.

### Example 92

The tubular type lead-acid battery Ve shown in FIGS. 5A, 5B, and 5C was made.

<<Making of Positive Electrode Body and Negative Electrode Body>>

Dipping a tube woven of glass fibers in a water dispersion liquid of a thermosetting resin, heating it at 90 degrees Celsius for one minute, and thereafter further heating it at 170 degrees Celsius for 40 seconds, thereby the tube member 30 was made. On the other hand, weighing and blending phenol activated carbon powders of 77 mass % of which a specific surface area is 1000 m²/g and graphite of 15 mass %, they were mixed well. Then adding to it a dispersion of polytetrafluoroethylene of 3 mass % so that the addition amount becomes 5 mass % as a solid content of polytetrafluoroethylene; and a hydroxyethylcellulose water solution of 1 mass % so that the addition amount becomes 3 mass % as a solid content of hydroxyethylcellulose, it was dryly kneaded.

Next, dipping the tube member 30 of which an outer perimeter surface was sealed up, the capacitor layer 33 was formed on an inner perimeter surface thereof. Then disposing a core metal made of a lead alloy as the electrode ear 34 at center of the tube member 30 and filling a positive electrode active substance around the ear 34, thereby the electrode portion 31 was formed. Next, the tube member 30 was dried at 120 degrees Celsius for 20 minutes. Then although the positive electrode body 26a shown in FIG. 5C is configured with six tube members 30, the body 26a in the example 92 was made by aligning and jointing fourteen tube members 30

Next, in the making process of the positive electrode body 26a was made the negative electrode body 26b similarly to the positive electrode body 26a except for using a negative electrode active substance instead of the positive electrode active substance.

<<Making of Tubular Type Lead-Acid Battery>>

Putting the made negative electrode body 26b in one bag 28 and using seven negative electrode bodies 26b put in the bags 28 and six made positive electrode bodies 26a, the tubular type lead-acid battery Ve shown in FIGS. 5A to 5C was made. As an electrolyte was used dilute sulfuric acid of specific gravity 1.28 (at 20 degrees Celsius). Meanwhile, adding dilute sulfuric acid of specific gravity 1.4 (at 20 degrees Celsius) after the conversion of the tubular type lead-acid battery Ve, the electrolyte was adjusted so as to become dilute sulfuric acid of a concentration of specific gravity 1.28 (at 20 degrees Celsius). A battery capacity of the obtained tubular type lead-acid battery Ve was 390 Ah, and an average discharge thereof voltage was 2V.

Then a discharge time and tenth second discharge voltage of when the tubular type lead-acid battery Ve was discharged at 15 CA were measured. A result thereof is shown in Table 11.

### Example 93

A cylindrical lead-acid battery was made similarly to the cylindrical lead-acid battery Vc of the example 90 except for forming the positive electrode capacitor layer 18 on both sides of the positive electrode plate 11a and not forming the negative electrode capacitor layer 19 on the negative electrode plate 10a.

Then a discharge time and tenth second discharge voltage of when the cylindrical lead-acid battery was discharged at 15 CA were measured. A result thereof is shown in Table 11.

### Example 94

A cylindrical lead-acid battery was made similarly to the cylindrical lead-acid battery Vc of the example 90 except for forming the positive electrode capacitor layer 18 only on one side of the positive electrode plate 11a and not forming the negative electrode capacitor layer 19 on the negative electrode plate 10a.

Then a discharge time and tenth second discharge voltage of when the cylindrical lead-acid battery was discharged at 15 CA were measured. A result thereof is shown in Table 11.

### Example 95

A cylindrical lead-acid battery was made similarly to the cylindrical lead-acid battery Vc of the example 90 except for forming the negative electrode capacitor layer 19 on both sides of the negative electrode plate 10a and not forming the positive electrode capacitor layer 18 on the positive electrode plate 11a.

Then a discharge time and tenth second discharge voltage of when the cylindrical lead-acid battery was discharged at 15 CA were measured. A result thereof is shown in Table 11.

### Example 96

A cylindrical lead-acid battery was made similarly to the cylindrical lead-acid battery Vc of the example 90 except for forming the negative electrode capacitor layer 19 only on one side of the negative electrode plate 10a and not forming the positive electrode capacitor layer 18 on the positive electrode plate 11a.

Then a discharge time and tenth second discharge voltage of when the cylindrical lead-acid battery was discharged at 15 CA were measured. A result thereof is shown in Table 11.

### Comparison Example 8

An automobile lead-acid battery was made similarly to the automobile lead-acid battery Vb of the example 89 except for not forming the positive electrode capacitor layer 18 on the positive electrode plate 11a and the negative electrode capacitor layer 19 on the negative electrode plate 10a.

Then a discharge time and tenth second discharge voltage of when the automobile lead-acid battery was discharged at 15 CA were measured. A result thereof is shown in Table 11.

### Comparison Example 9

A cylindrical lead-acid battery was made similarly to the cylindrical lead-acid battery Vc of the example 90 except for not forming the positive electrode capacitor layer 18 on the positive electrode plate 11a and the negative electrode capacitor layer 19 on the negative electrode plate 10a.

Then a discharge time and tenth second discharge voltage of when the cylindrical lead-acid battery was discharged at 15 CA were measured. A result thereof is shown in Table 11.

### Comparison Example 10

A valve-regulated lead-acid battery was made similarly to the valve-regulated lead-acid battery Vd of the example 91 except for not forming the positive electrode capacitor layer 18 on the positive electrode plate 11a and the negative electrode capacitor layer 19 on the negative electrode plate 10a.

Then a discharge time and tenth second discharge voltage of when the valve-regulated lead-acid battery was discharged at 15 CA were measured. A result thereof is shown in Table 11.

### Comparison Example 11

In the tubular type lead-acid battery Ve of the example 92 a positive electrode body and a negative electrode body were made similarly to the positive electrode body 26a and the negative electrode body 26b except for not forming the capacitor layer 33 on the inner perimeter surface of the tube member 30. Then a tubular type lead-acid battery was made similarly to the tubular type lead-acid battery Ve except for using the positive electrode body and negative electrode body made in the comparison example instead of the positive electrode body 26a and the negative electrode body 26b in the battery Ve.

Then a discharge time and tenth second discharge voltage of when the tubular type lead-acid battery was discharged at 15 CA were measured. A result thereof is shown in Table 11.

TABLE 11

| | Tenth Second | |
|---|---|---|
| | Discharge Voltage | Discharge Time |
| | (V) | (sec) |
| Example 89 | 11.3 | 62 |
| Example 90 | 11.7 | 70 |
| Example 91 | 1.77 | 59 |
| Example 92 | 1.74 | 55 |
| Example 93 | 11.5 | 62 |
| Example 94 | 11.2 | 59 |
| Example 95 | 11.6 | 64 |
| Example 96 | 11.3 | 60 |
| Comparison Example 8 | 10.7 | 35 |
| Comparison Example 9 | 10.8 | 40 |
| Comparison Example 10 | 1.59 | 20 |
| Comparison Example 11 | 1.64 | 15 |

<Evaluation of Discharge Time>

As apparent from contrasts between the example 89 and the comparison example 8; the examples 90, 93 to 96 and the comparison example 9; the example 91 and the comparison example 10; and the example 92 and the comparison example 11, the lead-acid batteries related to the examples of the 10 present invention are proved to be long in discharge time and high in tenth second discharge voltage, compared to those of the comparison examples.

What is claimed is:

1. A lead-acid battery electrode body comprising:
an electrode containing an active substance; and
a capacitor layer configured to accumulate an electric charge on a surface of the electrode.

2. The lead-acid battery electrode body according to claim 1, wherein the capacitor layer contains activated carbon, a binder, and a conductive auxiliary agent.

3. The lead-acid battery electrode body according to claim 2, wherein the activated carbon has a specific surface area not less than 700 m²/g and not more than 3500 m²/g, and the binder contains at least one of a fluorine resin, a cellulose resin, and a synthetic rubber.

4. The lead-acid battery electrode body according to claim 2, wherein the capacitor layer is a porous body.

5. A lead-acid battery comprising:
an electrode body;
an electrode containing an active substance; and
a capacitor layer configured to accumulate an electric charge on a surface of the electrode.

6. The lead-acid battery according to claim 5, wherein the capacitor layer is formed on one side or both sides of any of a plate form positive electrode and a plate form negative electrode.

7. The lead-acid battery according to claim 6, wherein the capacitor layer contains activated carbon, a binder, and a conductive auxiliary agent.

8. The lead-acid battery according to claim 7, wherein the activated carbon has a specific surface area not less than 700 m²/g and not more than 3500 m²/g.

9. The lead-acid battery according to claim 7, wherein the binder contains at least one of a fluorine resin, a cellulose resin, and a synthetic rubber.

10. The lead-acid battery according to claim 9 wherein the binder contains at least one of polytetrafluoroethylene, polyfluorovinylidene, polyvinyl alcohol, methylcellulose, carboxymethylcellulose, sodium carboxymethylcellulose, hydroxypropyl methylcellulose, hydroxymethylethylcellulose, hydroxyethylcellulose, polyethylene oxide, ethylene-propylene rubber, styrene-butadiene rubber, chlorosulfonated polyethylene rubber, nitrile rubber, methacrylate methyl-butadiene rubber, butyl glycol acetate, and ethyl diglycol acetate.

11. The lead-acid battery according to claim 10 wherein in combination the binder contains at least one of polytetrafluoroethylene, ethylene-propylene rubber, styrene-butadiene rubber, chlorosulfonated polyethylene rubber, nitrile rubber, and methacrylate methyl-butadiene rubber; and at least one of polyvinyl alcohol, methylcellulose, carboxymethylcellulose, sodium carboxymethylcellulose, hydroxypropyl methylcellulose, hydroxymethylethylcellulose, hydroxyethylcellulose, and polyethylene oxide.

12. The lead-acid battery according to claim 7, wherein the conductive auxiliary agent contains at least one of carbon black, acetylene black, furnace black, natural graphite, artificial graphite, isotropic graphite, mesophase carbon, pitch carbon fibers, vapor phase epitaxy carbon fibers, nanocarbon, and PAN (Polyacrylonitrile) carbon fibers.

13. The lead-acid battery according to claim 7, wherein the capacitor layer further contains any of a metallic lead powder and a lead compound.

14. The lead-acid battery according to claim 13, wherein the lead compound contains at least one of monobasic lead sulfate, tribasic lead sulfate, tetrabasic lead sulfate, sulfate lead, and a lead oxide.

15. The lead-acid battery according to claim 7, wherein a content of the binder in the capacitor layer is not less than 1 mass % and not more than 50 mass %.

16. The lead-acid battery according to claim 7, wherein a content of the conductive auxiliary agent in the capacitor layer is not less than 5 mass % and not more than 80 mass %.

17. The lead-acid battery according to claim 10, wherein the capacitor layer contains the polytetrafluoroethylene and has an ability of forming a melt adhesion layer in heat treatment.

18. The lead-acid battery according to claim 5, wherein an adhesion area ratio of the capacitor layer to a surface of the electrode is not less than 20% and less than 100%.

19. The lead-acid battery of a cylindrical lead-acid battery according to claim 5.

20. The lead-acid battery of a valve-regulated lead-acid battery according to claim 5.

21. The lead-acid battery of a tubular type lead-acid battery according to claim 5.

22. A manufacturing method of a lead-acid battery comprising:
a first process of adjusting a capacitor layer forming composition matter containing activated carbon, a binder, and a conductive auxiliary agent;
a second process of extending the capacitor layer forming composition matter on a surface of an electrode containing an active substance and forming a capacitor layer; and
a third process of housing the electrode, where the capacitor layer is formed, in a casing together with an electrolyte.

23. The manufacturing method according to claim 22, wherein the capacitor layer forming composition matter further contains any of a metallic lead powder and a lead compound.

24. The manufacturing method according to claim 22, wherein in the first process as the binder are used at least one of polytetrafluoroethylene, ethylene-propylene rubber, styrene-butadiene rubber, chlorosulfonated polyethylene rubber, nitrile rubber, and methacrylate methyl-butadiene rubber; and a water solution of at least one of polyvinyl alcohol, methylcellulose, carboxymethylcellulose, sodium carboxymethylcellulose, hydroxypropyl methylcellulose, hydroxymethylethylcellulose, hydroxyethylcellulose, and polyethylene oxide, and the capacitor layer forming composition matter is adjusted.

25. The manufacturing method according to claim 23, wherein in the first process are used a water solution or water dispersion solution of the binder of at least one of polytetrafluoroethylene, polyfluorovinylidene, polyvinyl alcohol, methylcellulose, carboxymethylcellulose, sodium carboxymethylcellulose, hydroxypropyl methylcellulose, hydroxymethylethylcellulose, hydroxyethylcellulose, polyethylene oxide, ethylene-propylene rubber, styrene-butadiene rubber, chlorosulfonated polyethylene rubber, nitrile rubber, methacrylate methyl-butadiene rubber, butyl glycol acetate, and ethyl diglycol acetate; and at least one of a metallic lead powder, monobasic lead sulfate, tribasic lead sulfate, tetrabasic lead sulfate, sulfate lead, and a lead oxide, and the capacitor layer forming composition matter is adjusted.

26. The manufacturing method according to claim 23, wherein kneading is performed with: a water solution or water dispersion solution of the binder of at least one of polytetrafluoroethylene, polyfluorovinylidene, polyvinyl alcohol, methylcellulose, carboxymethylcellulose, sodium carboxymethylcellulose, hydroxypropyl methylcellulose, hydroxymethylethylcellulose, hydroxyethylcellulose, polyethylene oxide, ethylene-propylene rubber, styrene-butadiene rubber, chlorosulfonated polyethylene rubber, nitrile rubber, methacrylate methyl-butadiene rubber, butyl glycol acetate, and ethyl diglycol acetate; at least one of a metallic lead powder, monobasic lead sulfate, tribasic lead sulfate, tetrabasic lead sulfate, sulfate lead, and a lead oxide; and a sulfuric acid water solution, and the capacitor layer forming composition matter is adjusted in a slurry form.
